(19) United States
(12) Patent Application Publication
(10) Pub. No.: US 2026/0067770 A1
(43) Pub. Date: Mar. 5, 2026

(54) PATH PROCESSING METHOD AND APPARATUS AND COMMUNICATION SYSTEM

(71) Applicant: FUJITSU LIMITED, Kawasaki-shi (JP)

(72) Inventors: Guorong LI, Beijing (CN); Meiyi JIA, Beijing (CN); Su YI, Beijing (CN); Xin WANG, Beijing (CN)

(73) Assignee: FUJITSU LIMITED, Kawasaki-shi (JP)

(21) Appl. No.: 19/342,936

(22) Filed: Sep. 29, 2025

Related U.S. Application Data
(63) Continuation of application No. PCT/CN2023/086741, filed on Apr. 6, 2023.

(51) Int. Cl. H04W 36/00; H04W 36/06; H04W 76/19; H04W 76/20

(52) U.S. Cl. CPC H04W 36/0079; H04W 36/06; H04W 76/19; H04W 76/20

(57) ABSTRACT

A path processing apparatus, applicable to a remote terminal equipment configured with an indirect path, includes: a first receiver configured to receive first indication information transmitted by a network device, the first indication information comprising an indication for adding or changing a direct path in addition to the indirect path; and first processor circuitry configured to initiate RRC reestablishment when a direct path is added or changed according to the first indication information and the adding or changing a direct path fails.

### CROSS-REFERENCE TO RELATED APPLICATION

This application is a continuation application under 35 U.S. C. 111(a) of International Patent Application PCT/CN2023/086741 filed on Apr. 6, 2023, and designated the U.S., the entire contents of which are incorporated herein by reference.

### TECHNICAL FIELD

This disclosure relates to the field of communication technologies.

### BACKGROUND

In Release 18 of the 3rd Generation Partnership Project (3GPP), benefits and possible solutions of supporting multi-path are being studied to enhance reliability and throughput. A scenario of the multi-path may be: a remote user equipment (UE) is connected to the same network device (e.g. a gNB) by using a direct path and an indirect path. For example, the direct path may be that the remote terminal equipment is connected directly to the network device via a Uu interface, and the indirect path may be that the remote user equipment is connected to the network device via a UE-to-network relay of layer 2 (L2).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in some operations of the multi-path, for example, a remote UE operating only on the indirect path adds a direct path under the same network device, or a remote UE operating on the multi-path (direct path and indirect path) changes the current direct path to direct paths of different cells under the same network device. When adding a direct path or changing the direct path fails, it's not specified about how the remote UE to operate;
in addition, in some operations of the multi-path, in a case of releasing the current direct path, it's not specified about how the remote UE to operate.

Embodiments of this disclosure provide a path processing method and apparatus and a communication system.

According to one aspect of the embodiments of this disclosure, there is provided a path processing apparatus, configured in a remote terminal equipment, the apparatus including:
a first receiving unit configured to receive first indication information transmitted by a network device, the first indication information including an indication for adding or changing a direct path; and
a first processing unit configured to initiate RRC reestablishment or transmit failure information to the network device when a direct path is added or changed according to the first indication information and the adding or changing a direct path fails.

According to another aspect of the embodiments of this disclosure, there is provided a path processing method, applicable to a remote terminal equipment, the method including:
receiving first indication information transmitted by a network device, the first indication information including an indication for adding or changing a direct path; and
initiating RRC reestablishment or transmitting failure information to the network device when a direct path is added or changed according to the first indication information and the adding or changing a direct path fails.

According to a further aspect of the embodiments of this disclosure, there is provided a path processing apparatus, configured in a remote terminal equipment, the apparatus including:
a first communication unit configured to communicate with a network device via a direct path and an indirect path; and
a first releasing unit configured to release the direct path,
wherein a primary cell (PCell) of the remote terminal equipment is a primary cell on the released direct path, or a primary cell of the remote terminal equipment is a serving cell of a relay terminal equipment on the indirect path.

According to still another aspect of the embodiments of this disclosure, there is provided a path processing method, applicable to a remote terminal equipment, the method including:
communicating with a network device via a direct path and an indirect path, and releasing the direct path,
wherein a primary cell (PCell) of the remote terminal equipment is a primary cell on the released direct path, or a primary cell of the remote terminal equipment is a serving cell of a relay terminal equipment on the indirect path.

According to yet another aspect of the embodiments of this disclosure, there is provided a path processing apparatus, configured in a remote terminal equipment, wherein the remote terminal equipment communicates with a network device by using a direct path and an indirect path and uses a mode-1 resource allocation mode, and the apparatus includes:
a second releasing unit configured to release a direct path; and
a second processing unit configured to use a mode-2 resource allocation mode.

According to yet still another aspect of the embodiments of this disclosure, there is provided a path processing method, applicable to a remote terminal equipment, wherein the remote terminal equipment communicates with a network device by using a direct path and an indirect path and uses a mode-1 resource allocation mode, and the method includes:
releasing a direct path; and
using a mode-2 resource allocation mode.

According to a yet further aspect of the embodiments of this disclosure, there is provided a path processing apparatus, configured in a network device, the apparatus including:
a first transmitting unit configured to transmit first indication information to a remote terminal equipment, the first indication information including an indication for adding or changing a direct path; and
a second receiving unit configured to receive an RRC reestablishment request message or failure information transmitted by the remote terminal equipment in adding or changing a direct path according to the first indication information and the adding or changing a direct path fails.

According to yet still another aspect of the embodiments of this disclosure, there is provided a path processing method, applicable to a network device, the method including:
transmitting first indication information to a remote terminal equipment, the first indication information including an indication for adding or changing a direct path; and
receiving an RRC reestablishment request message or failure information transmitted by the remote terminal equipment in adding or changing a direct path according to the first indication information and the adding or changing a direct path fails.

According to yet another aspect of the embodiments of this disclosure, there is provided a path processing apparatus, configured in a network device, the apparatus including:
a fourth communication unit configured to communicate via a direct path and an indirect path with a remote terminal equipment using a mode-1 resource allocation mode; and
a third transmitting unit configured to transmit second indication information to the remote terminal equipment, the second indication information including information indicating that the remote terminal equipment uses the mode-2 resource allocation mode in a case where a direct path is released.

According to yet another aspect of the embodiments of this disclosure, there is provided a path processing method, applicable to a network device, the method including:
communicating via a direct path and an indirect path by the network device with a remote terminal equipment using a mode-1 resource allocation mode; and
transmitting second indication information to the remote terminal equipment when the remote terminal equipment releases the direct path.

According to yet another aspect of the embodiments of this disclosure, there is provided a path processing apparatus, configured in a network device, the apparatus including:
a fifth communication unit configured to communicate via a direct path and an indirect path with a remote terminal equipment using a mode-1 resource allocation mode; and
a fourth transmitting unit configured to transmit third indication information to the remote terminal equipment, the third indication information including information indicating to release a direct path and information indicating to use a mode-2 resource allocation mode in a case of releasing a direct path.

According to yet another aspect of the embodiments of this disclosure, there is provided a path processing method, applicable to a network device, the method including:
communicating via a direct path and an indirect path with a remote terminal equipment using a mode-1 resource allocation mode; and
transmitting third indication information to the remote terminal equipment, the third indication information including information indicating to release a direct path and information indicating to use a mode-2 resource allocation mode in a case of releasing a direct path.

According to yet another aspect of the embodiments of this disclosure, there is provided a remote terminal equipment, including a memory and a processor, the memory storing a computer program, and the processor being configured to execute the computer program to carry out the path processing method at the remote terminal equipment side described above.

According to yet another aspect of the embodiments of this disclosure, there is provided a network device, including a memory and a processor, the memory storing a computer program, and the processor being configured to execute the computer program to carry out the path processing method at the network device side described above.

According to yet another aspect of the embodiments of this disclosure, there is provided a communication system, including:
a remote terminal equipment configured to execute the path processing method at the remote terminal equipment side described above; and
a network device configured to execute the path processing method at the network device side described above.

An advantage of the embodiments of this disclosure exists in that the remote terminal equipment may initiate RRC reestablishment or transmit failure information to the network device when adding a direct path or changing the direct path fails, which solves the problem in the related art. Hence, as behaviors of the remote terminal equipment when adding a direct path or changing the direct path fails are regulated, it is beneficial for the remote terminal equipment and the network device to have a consistent understanding of the configuration of the remote terminal equipment and avoid configuration conflicts or mismatches.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including/comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of the embodiments of this disclosure;

FIG. 2 is a schematic diagram of a scenario of the embodiments of this disclosure;

FIG. 3 is a schematic diagram of a scenario of the embodiments of this disclosure;

FIGS. 4-6 are schematic diagrams of the path processing methods of the embodiments of this disclosure;

FIGS. 7-16 are schematic diagrams of flows of information exchange of the embodiments of this disclosure;

FIG. 17 is a schematic diagram of the path processing method of the embodiments of this disclosure;

FIG. 18 is a schematic diagram of the path processing method of the embodiments of this disclosure;

FIG. 19 is a schematic diagram of the path processing method of the embodiments of this disclosure;

FIG. 20 is a schematic diagram of the path processing method of the embodiments of this disclosure;

FIGS. 21-22 are schematic diagrams of flows of information exchange of the embodiments of this disclosure;

FIG. 23 is a schematic diagram of the path processing method of the embodiments of this disclosure;

FIG. 24 is a schematic diagram of a flow of information exchange of the embodiments of this disclosure;

FIG. 25 is a schematic diagram of the path processing method of the embodiments of this disclosure;

FIG. 26 is a schematic diagram of the path processing method of the embodiments of this disclosure;

FIG. 27 is a schematic diagram of the path processing method of the embodiments of this disclosure;

FIG. 28 is a schematic diagram of the path processing apparatus of the embodiments of this disclosure;

FIG. 29 is a schematic diagram of the path processing apparatus of the embodiments of this disclosure;

FIG. 30 is a schematic diagram of the path processing apparatus of the embodiments of this disclosure;

FIG. 31 is a schematic diagram of the path processing apparatus of the embodiments of this disclosure;

FIG. 32 is a schematic diagram of the path processing apparatus of the embodiments of this disclosure;

FIG. 33 is a schematic diagram of the path processing apparatus of the embodiments of this disclosure;

FIG. 34 is a schematic diagram of the path processing apparatus of the embodiments of this disclosure;

FIG. 35 is a schematic diagram of the terminal equipment of the embodiments of this disclosure; and

FIG. 36 is a schematic diagram of the network device of the embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims. The embodiments of this disclosure shall be described below with reference to the accompanying drawings. These embodiments are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE)” or “remote user equipment” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, a machine to machine (M2M) terminal, and a terminal supporting sidelink communication, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment.

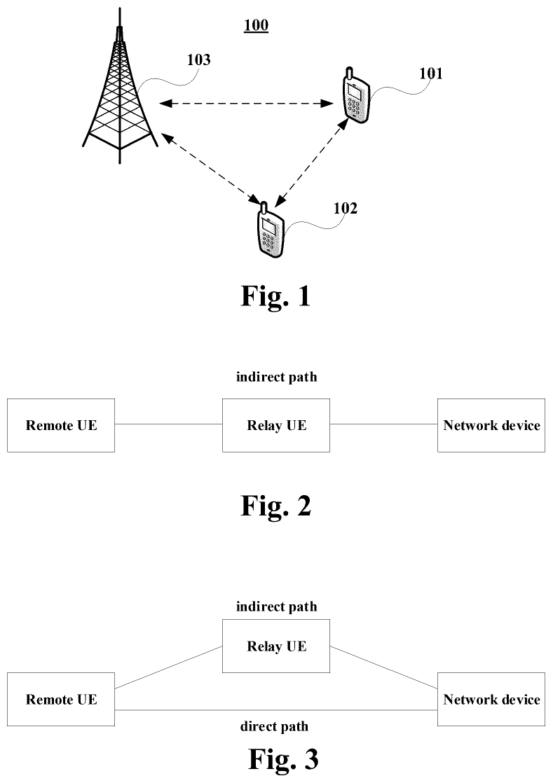

FIG. 1 is a schematic diagram of a communication system of the embodiments of this disclosure, illustrating a case taking a remote terminal equipment, a relay terminal equipment and a network device as an example. As shown in FIG. 1, the communication system 100 may include a remote terminal equipment 101, a relay terminal equipment 102 and a network device 103. The remote terminal equipment 101 is connected to the network device 103 via a direct path and/or an indirect path. For the sake of simplicity, description is given in FIG. 1 by taking two terminal equipments (one remote terminal equipment and one relay terminal equipment) and one network device as an example; however, the embodiments of this disclosure is not limited thereto.

In the embodiments of this disclosure, existing services or services that may be implemented in the future may be performed between the network device 103 and the remote terminal equipment 101 and the relay terminal equipment 102. For example, such services may include but not limited to an enhanced mobile broadband (eMBB), massive machine type communication (mMTC), ultra-reliable and low-latency communication (URLLC), etc.

FIG. 2 is a schematic diagram of a scenario of the embodiments of this disclosure. As shown in FIG. 2, the remote terminal equipment (remote UE) communicates with the network device (such as a gNB) via an indirect path, wherein an interface between the remote terminal equipment and the relay terminal equipment is a PC5 interface, sidelink communication is used, and an interface between the relay terminal equipment and the network device is a Uu interface. For example, the remote terminal equipment may communicate with the network device via the relay terminal equipment (the indirect path).

FIG. 3 is a schematic diagram of a scenario of the embodiments of this disclosure. As shown in FIG. 3, the remote terminal equipment (remote UE) communicates with the network device (such as a gNB) via a direct path and an indirect path simultaneously. For example, the remote terminal equipment may communicate with the network device via a Uu interface (the direct path) and communicate with the same network device via the relay terminal equipment (the indirect path).

In some embodiments, the direct path between the remote terminal equipment and the network device uses a Uu interface protocol stack, and the indirect path between the remote terminal equipment and the network device is transmitted via L2 UE-to-network relay, wherein a PC5 interface and a Uu interface protocol stack are used.

For operations in multi-path, following viewpoints have been agreed in the 3rd Generation Partnership Project (3GPP):
a remote UE operating only on an indirect path adds a direct path under the same gNB;
a remote UE operating in multi-path releases a direct path;
a remote UE operating in multi-path is changed to direct paths of different cells of the same gNB, and uses a service relay UE to an indirect path under the same gNB.

It was found by the inventors that a remote UE operating only on the indirect path adds a direct path under the same network device, or a remote UE operating on the multi-path changes the current direct path to direct paths of different cells under the same network device. When adding a direct path or changing the direct path fails, it's not specified about how the remote UE to operate.

In addition, in some scenarios of the multi-path, in multi-path operations of the remote UE, a primary cell (PCell) is located in the direct path, and after the direct path is released, the remote UE is controlled by a serving cell of a relay UE on the indirect path. It was found by the inventors that after the direct path is released, it's not specified about which cell is the PCell of the remote UE.

Furthermore, in some scenarios of multi-path, such as in multi-path operations of the remote UE, the remote UE may be configured to use a resource allocation mode of mode 1 in the case of multi-path. However, it was found by the inventors that a resource allocation mode used by remote UE after the direct path is released is not specified.

Therefore, when the remote UE adds or changes the direct path and the adding or changing the direct path fails, how the remote terminal equipment to operate is a problem needing to be solved; in addition, after the remote UE releases the direct path in the multi-path operations, how to determine a primary cell of the remote UE or a used resource allocation mode is a problem needing to be solved.

Addressed to at least one of the above problems, the embodiments of this disclosure provide a path processing method and apparatus and a communication system.

Implementations of the embodiments of this disclosure shall be described below with reference to the accompanying drawings. These implementations are illustrative only, and are not intended to limit this disclosure.

### Embodiments of a First Aspect

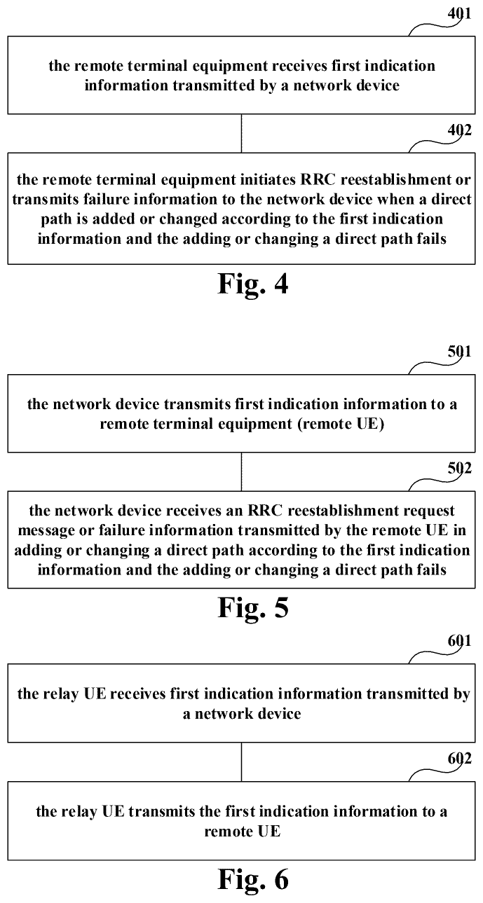

FIG. 4 is a schematic diagram of the path processing method of the embodiments of this disclosure. As shown in FIG. 4, the method is applicable to a remote terminal equipment and includes:
401: the remote terminal equipment receives first indication information transmitted by a network device, the first indication information including an indication for adding or changing a direct path; and
402: the remote terminal equipment initiates RRC reestablishment or transmits failure information to the network device when a direct path is added or changed according to the first indication information and the adding or changing a direct path fails.

According to the above embodiments, the remote terminal equipment (remote UE) may initiate RRC reestablishment or transmit failure information to the network device when the remote UE adds or changes a direct path and the adding or changing the direct path fails. Hence, operations of the remote UE when adding a direct path or changing the direct path fails are regulated, which solves the problem in the related art, and is beneficial for the remote UE and the network device to have a consistent understanding of the configuration of the remote UE, and configuration conflicts or mismatches are avoided.

It should be noted that FIG. 4 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

In some embodiments, when the remote UE operates only via an indirect path, such as in the scenario shown in FIG. 2, in 401, the received first indication information includes the indication for adding a direct path, hence, in 402, a direct path may be added according to the first indication information. In the case where adding a direct path fails, RRC reestablishment may be initiated or the failure information may be transmitted to the network device. For example, the remote UE may receive via an indirect path (such as a relay UE) the first indication information transmitted by the network device, which is not limited in the embodiments of this disclosure.

In this case, the first indication information may include configuration of a primary cell (PCell) in the added direct path (such as including downlink frequency information and a physical cell identifier (PCI), and resource configuration and/or preamble configuration related to random access in the PCell), and furthermore, it may include configuration of a secondary cell (SCell) and/or configuration of MAC and/or RLC bearer configuration and/or radio bearer configuration and/or security configuration, etc. in the added direct path.

In some embodiments, when the remote UE operates via multi-path, such as in the scenario shown in FIG. 3, in 401, the received first indication information includes an indication for changing a direct path. Therefore, in 402, the direct path may be changed according to the first indication information. In a case where changing the direct path fails, RRC reestablishment is initiated or the failure information is transmitted to the network device. For example, changing the direct path refers to changing a current direct path (such as direct path 1) to a direct path (direct path 2) of a different cell under the network device. Hence, in 402, the direct path may be changed according to the first indication information, that is, releasing direct path 1 and adding direct path 2. In the case where changing the direct path fails (i.e. adding a new direct path fails), RRC reestablishment is initiated or the failure information is transmitted to the network device. For example, the remote UE may receive via a direct path and/or an indirect path the first indication information transmitted by the network device. Use of a direct path or indirect path is not limited in the embodiments of this disclosure. For example, use of a direct path or indirect path may be preconfigured, so that the remote UE may receive the first indication message according to the preconfiguration.

In this case, the first indication information may further include configuration of the PCell in the changed direct path. For example, the configuration may include downlink frequency information and a physical cell identifier (PCI), and may further include resource configuration and/or preamble configuration related to random access in the PCell; in addition, the first indication information may include configuration of an SCell and/or configuration of MAC and/or configuration of an RLC bearer and/or configuration of a radio bearer and/or security configuration, etc. in the changed direct path.

In addition, in this case, a time when the remote UE releases a current direct path (such as direct path 1) is not limited here, and it may be released before or after adding new direct path 2. The message for releasing the current direct path may be included in the first indication information, and transmitted together with the indication for changing a direct path, or may be transmitted separately from the first indication information. For example, it may be transmitted before or after transmitting the first indication information, which is not limited here.

In some embodiments, the network device may transmit the first indication information via an existing message, such as transmitting the first indication information via RRC reconfigure message, or transmitting the first indication information via a new message, which is not limited here.

In the embodiments, in a case where SRB (signaling radio bearer) 1 or split SRB1 or duplication SRB1 is configured on the indirect path, an RRC reconfiguration complete message (i.e. a configuration complete message for the first indication information, not shown) of the remote terminal equipment is transmitted to the network device via the indirect path.

In some embodiments, in 402, when a direct path is added or changed according to the first indication information and the adding or changing a direct path fails, RRC reestablishment may be initiated or the failure information may be transmitted to the network device.

When the remote UE adds or changes the direct path according to the first indication information, the remote UE may initiate a random access procedure. If random access to a target cell is not successful when timer T304 expires, it indicates that the adding or changing a direct path fails. The random access procedure is similar to that in the related art, which shall not be described herein any further.

In addition, in the case where the adding or changing a direct path fails, the remote UE may turn back to previous configuration (such as initial single-path (indirect path) or multi-path (direct and indirect paths) configuration), such as turning back to configuration before the first indication information is received. For example, in the scenario shown in FIG. 2, the previous configuration is configuration where the remote UE communicates with the network device (such as a gNB) by using an indirect path (relay UE), and in the scenario shown in FIG. 3, the previous configuration is configuration where the remote UE communicates with the network device by using a direct path and/or an indirect path. Hence, the remote UE may communicate with the network device (such as a gNB) via the previous configuration, such as initiating RRC reestablishment by using the previous configuration or transmitting the failure information to the network device; however, it is not limited thereto. In addition, in some embodiments, in the case where the adding or changing a direct path fails, the remote UE may also communicate with the network device by using default configuration, such as initiating RRC reestablishment or transmitting the failure information to the network device by using the default configuration, or communicating with the network device according to configuration of the indirect path indicated by the network side; however, it is not limited thereto.

In some embodiments, when the remote UE communicates with the network device by using the configuration of the indirect path indicated by the network side, the method may further include (not shown): receiving configuration information transmitted by the network device, the configuration information including the configuration of an indirect path. For example, the configuration information may be included in the first indication information and transmitted together with the indication for adding or changing a direct path. However, the embodiments are not limited thereto, and the information may also be transmitted separately, or may be transmitted before or after the first indication information is transmitted, which is not limited here.

In some embodiments, the previous configuration and/or the default configuration and/or the configuration of the indirect path indicated by the network side include(s) at least one of the following: configuration of a radio bearer, configuration of security, configuration of an RLC bearer, configuration of MAC, configuration of a physical layer, or configuration of SRAP, etc.

In some embodiments, the default configuration may be predefined configuration or configuration provided in a standard, and the default configuration include configuration using an indirect path, or configuration using a direct path and an indirect path.

Following description shall be given by taking that the remote UE initiates RRC reestablishment and transmits failure information as an example, and these implementations are illustrative only, and are not intended to limit this disclosure.

For example, in 402, when a direct path is added or changed according to the first indication information and the adding or changing a direct path fails, the remote UE initiates RRC reestablishment.

The remote UE may initiate RRC reestablishment in an existing method, such as initiating cell selection or relay selection, transmitting an RRC reestablishment request message to the network device in a case where a suitable cell or a suitable relay is found before a timer (e.g. T311 timer) expires, and transmitting an RRC establishment request message to the network device in a case where a suitable cell or a suitable relay is not found when a timer (e.g. T311 timer) expires.

For example, the remote terminal equipment initiates an RRC reestablishment procedure, and releases a PCell configuration and an SRAP configuration of the remote terminal equipment, etc., and the remote terminal equipment may release PC5 connection with the relay terminal equipment, and initiate cell selection or relay selection, or the remote terminal equipment may maintain the PC5 connection with the relay terminal equipment, deem that the relay terminal equipment is a suitable relay, transmit an RRC reestablishment request message to the network device via a Uu interface (a direct path) in a case where a suitable cell is found before a timer (e.g. T311 timer) expires, and transmit an RRC reestablishment request message to the network device via the relay UE (an indirect path) in a case where a suitable relay is found before a timer (e.g. T311 timer) expires. Among them, remote UE may communicate with the network device by using a default configuration, that is, initiating an RRC reestablishment procedure by using the default configuration, such as transmitting the RRC reestablishment request message to the network device via the default configuration.

A specific reestablishment procedure is similar to that in the related art, which shall not be repeated herein any further.

In some embodiments, in 402, when a direct path is added or changed according to the first indication information and the adding or changing a direct path fails, the remote UE transmits the failure information to the network device.

For example, in the scenario shown in FIG. 2, in a case where the first indication information includes the indication for adding a direct path, when a direct path is added or changed according to the first indication information and the adding or changing a direct path fails, the remote UE may transmit the failure information to the network device via an indirect path. For example, the failure information may be transmitted to the network device by using a previous configuration of an indirect path, a configuration of a default indirect path or a configuration of the indirect path indicated by the network side.

For example, in the scenario shown in FIG. 3, in a case where the first indication information includes the indication for adding a direct path, when a direct path is added or changed according to the first indication information and the adding or changing a direct path fails, the remote UE may transmit the failure information to the network device via a direct path and/or an indirect path. For example, the failure information may be transmitted to the network device by using a previous configuration of a direct path and/or an indirect path, a configuration of a direct path and/or an indirect path in a default configuration or a configuration of the indirect path indicated by the network side.

In some embodiments, the failure information includes a cause for failure. The cause for failure may be expressed as a failure type. For example, the cause for failure includes but is not limited to at least one of the following: failure in adding a direct path, failure in random access, failure in changing a direct path, or expiration of a timer (such as T304 timer).

In some embodiments, the failure information is an RRC message or an indication message of a lower layer. The indication message of a lower layer is, for example, a PDCP control PDU, or an RLC control PDU, or an MAC CE, etc.

It can be seen from the above embodiments that the remote terminal equipment may initiate RRC reestablishment or transmit failure information to the network device when adding or changing a direct path fails, which solves problems existing in the related art. Hence, as behaviors of the remote terminal equipment when adding or changing a direct path fails are specified, it is beneficial for the remote terminal equipment and the network device to have consistent understandings of the configuration of the remote terminal equipment, thereby avoiding configuration conflicts or mismatches.

### Embodiments of a Second Aspect

The embodiments of this disclosure provide a path processing method.

FIG. 5 is a schematic diagram of the path processing method of the embodiments of this disclosure. As shown in FIG. 5, the method is applicable to a network device and includes:
501: the network device transmits first indication information to a remote terminal equipment (remote UE), the first indication information including an indication for adding or changing a direct path; and
502: the network device receives an RRC reestablishment request message or failure information transmitted by the remote UE in adding or changing a direct path according to the first indication information and the adding or changing a direct path fails.

According to the above embodiments, the network device transmits the indication for adding or changing a direct path to the remote terminal equipment, and may receive the RRC reestablishment request message or failure information transmitted by the remote UE when the adding or changing fails. Hence, behaviors of the remote terminal equipment when adding or changing a direct path fails are specified, and problems in the related art are solved, which is beneficial for the remote UE and the network device to have consistent understandings of the configuration of the remote UE, thereby avoiding configuration conflicts or mismatches.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, the remote UE communicates with the network device via an indirect path. For example, in the scenario shown in FIG. 2, in 501, the first indication information includes an indication for adding a direct path. The network device may transmit the first indication information to the remote UE via an indirect path (relay UE). And when the remote terminal equipment adds a direct path according to the first indication information and the adding a direct path fails, in 502, the network device may receive the RRC reestablishment request message or failure information transmitted by the remote UE. For example, the network device may receive via a configuration of an indirect path the RRC reestablishment request message or failure information transmitted by the remote UE. The configuration of the indirect path may be an initial (previous) single-path(indirect path) configuration, or a configuration of an indirect path included in a default configuration, or a configuration of an indirect path used by the remote UE indicated by the network device, which are as described in the embodiments of the first aspect, which shall not be repeated herein any further.

In some embodiments, the remote UE communicates with the network device via a direct path and/or an indirect path. For example, in the scenario shown in FIG. 3, in 501, the first indication information includes an indication for changing a direct path. The network device may transmit the first indication information to the remote UE via a direct path and/or an indirect path (relay UE). And when the remote terminal equipment changes a direct path according to the first indication information and the changing a direct path fails, in 502, the network device may receive the RRC reestablishment request message or failure information transmitted by the remote UE. For example, the network device may receive via a configuration of a direct path and/or a configuration of an indirect path the RRC reestablishment request message or failure information transmitted by the remote UE. The configuration of the direct path may be an initial (previous) configuration of the direct path configuration, or a configuration of a direct path included in a default configuration; and the configuration of the indirect path may be an initial (previous) configuration of the indirect path, or a configuration of an indirect path included in a default configuration, or a configuration of an indirect path used by the remote UE indicated by the network device, which are as described in the embodiments of the first aspect, which shall not be repeated herein any further.

In some embodiments, in a case of using the configuration of the indirect path indicated by the network side, the method further includes (not shown in figures): transmitting configuration information to the remote terminal equipment, the configuration information including the configuration of the indirect path.

In some embodiments, the configuration information included in the previous configuration or the default configuration or the configuration indicated by the network side is as described in the embodiments of the first aspect, and shall not be repeated herein any further.

The configuration information may be included in the first indication information and transmitted to the remote UE simultaneously with the first indication information, or it may be transmitted separately from the first indication information and transmitted before or after the first indication information, which is not limited in this disclosure.

In some embodiments, the failure information and transmission of the failure information are as described in the embodiments of the first aspect, which are incorporated herein, and shall not be repeated herein any further.

It can be seen from the above embodiments that the network device receives the RRC reestablishment message or failure information transmitted by the remote terminal equipment when adding or changing a direct path fails, which solves problems existing in the related art. Hence, as behaviors of the remote terminal equipment when adding or changing a direct path fails are specified, it is beneficial for the remote terminal equipment and the network device to have consistent understandings of the configuration of the remote terminal equipment, thereby avoiding configuration conflicts or mismatches.

### Embodiments of a Third Aspect

The embodiments of this disclosure provide a path processing method.

FIG. 6 is a schematic diagram of the path processing method of the embodiments of this disclosure. As shown in FIG. 6, the method is applicable to a relay terminal equipment (relay UE) and includes:
601: the relay UE receives first indication information transmitted by a network device, the first indication information including an indication for adding or changing a direct path; and
602: the relay UE transmits the first indication information to a remote UE.

It can be seen from the above embodiments that the network device forwards the first indication information via the relay UE, so that the remote UE transmits the RRC reestablishment request message or failure information when it adds or changes a direct path according to the first indication information and the adding or changing a direct path fails. Hence, behaviors of the remote terminal equipment when adding or changing a direct path fails are specified, which solves problems existing in the related art, and is beneficial for the remote UE, the relay UE and the network device to have consistent understandings of the configuration of the remote UE, thereby avoiding configuration conflicts or mismatches.

In some embodiments, the method may further include (not shown in figures): receiving configuration information transmitted by the network device, the configuration information including a configuration of an indirect path; and transmitting the configuration information to the remote UE. Therefore, after receiving the configuration information, the remote UE may communicate with the network device by using the configuration of the indirect path in the configuration information.

In some embodiments, the method may further include (not shown in figures): receiving an RRC reestablishment request message or failure information transmitted by the remote UE in adding or changing a direct path according to the first indication information and the adding or changing a direct path fails; and transmitting the RRC reestablishment request message or failure information to the network device.

In some embodiments, the first indication information is transmitted via an RRC reconfiguration message.

In some embodiments, the failure information and transmission of the failure information are as described in the embodiments of the first aspect, which are incorporated herein, and shall not be repeated herein any further.

In the above embodiments, the relay UE does not parse contents of the RRC message of the remote UE.

It can be seen from the above embodiments that the relay UE forwards the first indication information transmitted by the network device to the remote UE, so that the remote UE transmits the RRC reestablishment request message or failure information when it adds or changes a direct path according to the first indication information and the adding or changing a direct path fails. Hence, behaviors of the remote terminal equipment when adding or changing a direct path fails are specified, which solves problems existing in the related art, and is beneficial for the remote UE, the relay UE and the network device to have consistent understandings of the configuration of the remote UE, thereby avoiding configuration conflicts or mismatches.

Various implementations of this disclosure shall be described below with reference to the accompanying drawings. These implementations are illustrative only, and are not intended to limit this disclosure.

### Embodiments of a Fourth Aspect

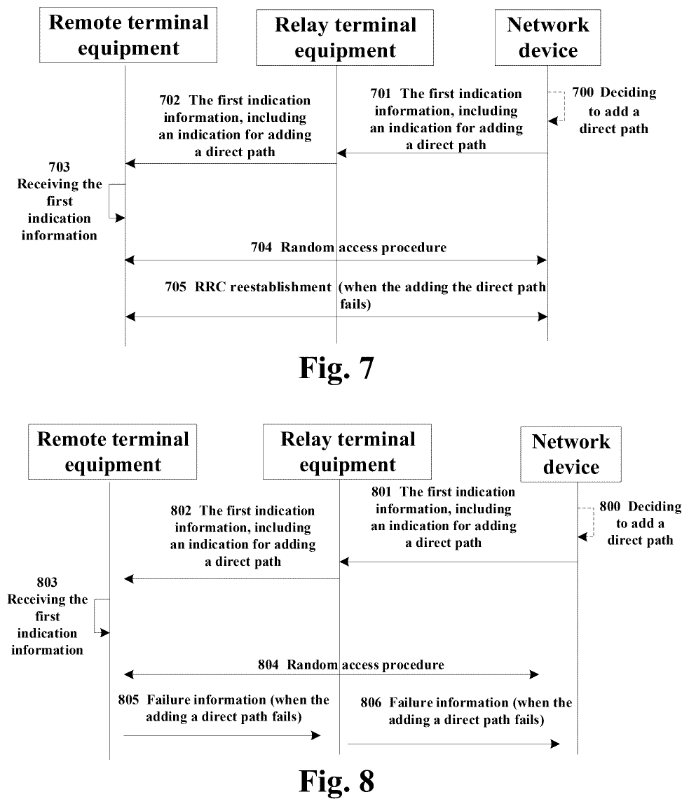

FIG. 7 is a schematic diagram of the path processing method of the embodiments of this disclosure, which shall be described by taking a scenario where a remote UE communicates with a network device only via an indirect path (as shown in FIG. 2) as an example. As shown in FIG. 7, the method includes:
701: the network device transmits first indication information to the remote UE via a relay UE, the first indication information including an indication for adding a direct path;
for example, the first indication information may be transmitted via an indirect path, that is, it is transmitted to the remote UE via the relay UE. For example, the first indication information may be transmitted via an RRC reconfiguration message;
702: the relay UE receives the first indication information, and transmits the first indication information to the remote UE;
703: the remote UE receives the first indication information transmitted by the network device via the relay UE;
704: the remote UE adds a direct path according to the first indication information;
for example, a random access procedure may be initiated, which is similar to that in the related art and will not be repeated here; and if the random access procedure fails (such as random access is not successful when timer T304 expires), it indicates that the adding the direct path fails;
705: initiating RRC reestablishment when the adding the direct path fails,
wherein cell selection or relay UE selection may be initiated.

In the above embodiments, reference may be made to the embodiments of the first aspect for 704 and 705, which shall not be repeated herein any further.

In some embodiments, as shown in FIG. 7, the method further includes:
700: deciding to add a direct path,
wherein the network device may decide to add a direct path according to a measurement report fed back by the remote UE, so as to transmit the first indication information. For example, the network device may transmit a measurement configuration message to the remote UE via an indirect path, and the remote UE performs measurement based on the measurement configuration message, and feeds back measurement reporting via the relay UE. Therefore, the network device may decide to add a direct path according to the measurement reporting.

It can be seen from the above embodiments that in the case where the remote UE communicates with the network device only via the indirect path (as shown in FIG. 2), the remote terminal equipment transmits the RRC reestablishment message to the network device when adding or changing a direct path fails, which solves problems existing in the related art. Hence, as behaviors of the remote terminal equipment when adding or changing a direct path fails are specified, it is beneficial for the remote terminal equipment and the network device to have consistent understandings of the configuration of the remote terminal equipment, thereby avoiding configuration conflicts or mismatches.

### Embodiments of a Fifth Aspect

FIG. 8 is a schematic diagram of the path processing method of the embodiments of this disclosure, which shall be described by taking a scenario where a remote UE communicates with a network device only via an indirect path (as shown in FIG. 2) as an example. As shown in FIG. 8, the method includes:
801: the network device transmits first indication information to the remote UE via a relay UE, the first indication information including an indication for adding a direct path;
802: the relay UE receives the first indication information, and transmits the first indication information to the remote UE;
803: the remote UE receives, the first indication information transmitted by the network device via the relay UE.
804: the remote UE adds a direct path according to the first indication information;
805: transmitting failure information to the network device via the relay UE when the adding a direct path fails;
for example, the failure information may be transmitted by using a previous configuration or a default configuration or a configuration indicated by the network side, that is, transmitting the failure information by using a previous configuration of the indirect path or a configuration of an indirect path in the default configuration or a configuration of an indirect path indicated by the network device, the previous configuration or the default configuration or the configuration indicated by the network side being as described in the embodiments of the first aspect, which shall not be repeated herein any further;
806: the relay UE forwards the failure information to the network device.

In some embodiments, as shown in FIG. 8, the method further includes:
800: deciding to add a direct path.

In the above embodiments, steps 800-804 are similar to steps 700-704 shown in FIG. 7, which are incorporated herein, and shall not be repeated herein any further.

In some embodiments, in 805, the default configuration may be a predefined configuration or a specified configuration, and may include at least one of the following: configuration of a radio bearer, a security configuration, a configuration of an RLC bearer, an MAC configuration, a physical layer configuration, or an SRAP configuration, etc.

In some embodiments, the method further includes (not shown in figures): receiving configuration information transmitted by the network device, the configuration information including the configuration of the indirect path. Hence, in 805, the remote UE may communicate with the network device based on the configuration of the indirect path indicated by the network device. This configuration information may be included in the first indication information for transmission in 801, or may be transmitted separately. A time of transmission is not limited, and it may be transmitted before the failure information is transmitted in 805.

In addition, in the embodiments described in FIGS. 7 and 8, in steps 701 and 801, the relay terminal equipment via which the network device transmits the first indication information and the relay terminal equipment via which the remote UE initiates RRC reestablishment or transmits the failure information may be identical or different, and FIGS. 7 and 8 are illustrative only. For example, the previous configuration of the indirect path is used by the network device in transmitting the first indication information and the remote UE in initiating RRC reestablishment or transmitting the failure information, and the relay UEs in FIGS. 7 and 8 are the relay UE on the previous indirect path. For example, when the network device transmits the first indication information, it uses the previous configuration of the indirect path, while the configuration used in initiating RRC reestablishment or transmitting the failure information is not the previous configuration of the indirect path. The relay UEs in FIGS. 7 and 8 are two different relay UEs, and only one relay UE is illustrated in the figures for simplicity.

It can be seen from the above embodiments that in the scenario where the remote UE communicates with the network device only via the indirect path (as shown in FIG. 2), the remote terminal equipment transmits the failure information to the network device when adding a direct path fails, which solves problems existing in the related art. Hence, as behaviors of the remote terminal equipment when adding a direct path fails are specified, it is beneficial for the remote terminal equipment and the network device to have consistent understandings of the configuration of the remote terminal equipment, thereby avoiding configuration conflicts or mismatches.

### Embodiments of a Sixth Aspect

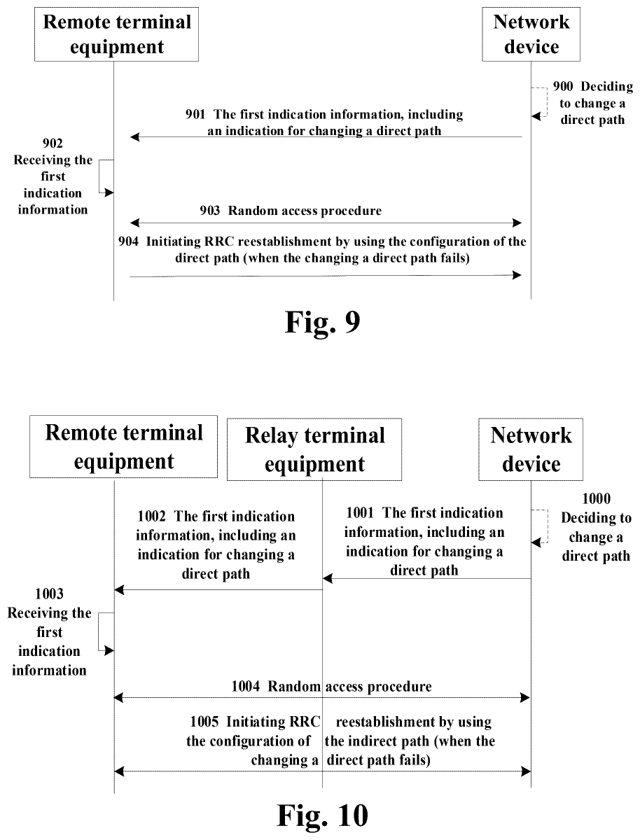

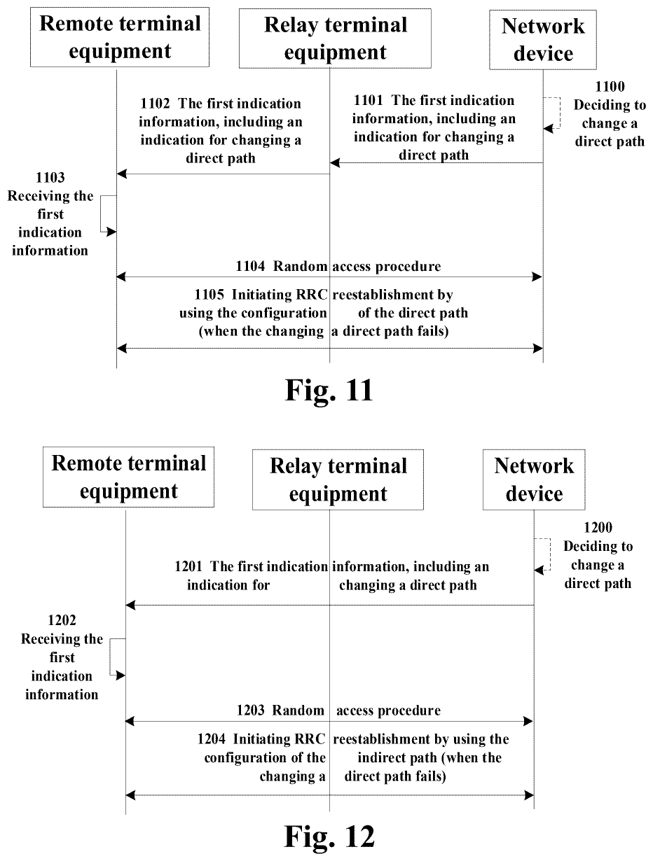

FIGS. 9-12 are schematic diagrams of the path processing methods of embodiments of this disclosure, which shall be described by taking a scenario where a remote UE communicates with a network device via a direct path and an indirect path (as shown in FIG. 3) as an example. FIG. 9 is a schematic diagram of communicating by the remote UE with the network device via a direct path throughout the entire procedure, FIG. 10 is a schematic diagram of communicating by the remote UE with the network device via an indirect path throughout the entire procedure, and FIGS. 11 and 12 are schematic diagrams of communicating by the remote UE with the network device via a direct path and an indirect path.

In some embodiments, as shown in FIG. 9, in the case where the remote UE communicates with the network device via a direct path throughout the entire procedure, the method includes:
901: the network device transmits the first indication information directly to the remote UE, the first indication information including an indication for changing a direct path;
902: the remote UE receives the first indication information transmitted by the network device;
903: the remote UE changes a direct path according to the first indication information;
for example, a random access procedure may be initiated, which is similar to that in the related art, and shall not be repeated herein any further; and if the random access procedure fails (such as random access is not successful when timer T304 expires), it indicates that the changing a direct path fails;
904: initiating RRC reestablishment when the changing a direct path fails,
wherein cell selection or relay UE selection may be initiated, and in a case where a suitable cell is found before T311 expires, an RRC reestablishment request may be transmitted via the direct path.

In some embodiments, as shown in FIG. 9, the method further includes:
900: deciding to change a direct path,
wherein the network device may decide to change a direct path according to a measurement report fed back by the remote UE, so as to transmit the first indication information. For example, the network device may transmit a measurement configuration message to the remote UE via a direct path and/or an indirect path, and the remote UE performs measurement based on the measurement configuration message, and feeds back measurement reporting via the direct path and/or the indirect path. Therefore, the network device may decide to change a direct path based on the measurement reporting.

In some embodiments, as shown in FIG. 10, when the remote UE communicates with the network device via an indirect path throughout the entire procedure, the method includes:
1001: the network device transmits the first indication information to the remote UE via the relay UE, the first indication information including an indication for changing a direct path;
1002: the relay UE forwards the first indication information to the remote UE;
1003: receiving, by the remote UE, the first indication information transmitted by the network device via the relay UE;
1004: the remote UE changes a direct path according to the first indication information;
for example, a random access procedure may be initiated, which is similar to that in the related art, and shall not be repeated herein any further; and if the random access procedure fails (such as random access is not successful when timer T304 expires), it indicates that the changing a direct path fails;
1005: initiating RRC reestablishment when the changing a direct path fails, and in a case where a suitable relay UE is found before T311 expires, transmitting an RRC reestablishment request via an indirect path.

In some embodiments, as shown in FIG. 10, the method further includes:
1000: deciding to change a direct path.

In some embodiments, as shown in FIG. 11, when the remote UE communicates with the network device via a direct path and an indirect path, for example, the network device transmits the first indication information via the indirect path, the remote UE initiates RRC reestablishment, finds a suitable cell, and transmits an RRC reestablishment request via the direct path. The method includes:
1101: the network device transmits the first indication information to the remote UE via the relay UE, the first indication information including an indication for changing a direct path;
1102: the relay UE forwards the first indication information to the remote UE;
1103: the remote UE receives the first indication information transmitted by the network device via the relay UE;

1104: the remote UE changes a direct path according to the first indication information, such as initiating a random access procedure, which is similar to that in the related art, and shall not be repeated herein any further;
1105: initiating RRC reestablishment when the changing a direct path fails, and in a case where a suitable cell is found before T311 expires, transmitting an RRC reestablishment request via a direct path.

In some embodiments, as shown in FIG. 11, the method further includes:
1100: deciding to change a direct path.

In some embodiments, as shown in FIG. 12, when the remote UE communicates with the network device via a direct path and an indirect path, for example, the network device transmits the first indication information via the indirect path, the remote UE initiates RRC reestablishment, and transmits an RRC reestablishment request via the indirect path if a suitable cell is found. The method includes:
1201: the network device transmits the first indication information to the remote UE, the first indication information including an indication for changing a direct path;
1202: the remote UE receives the first indication information transmitted by the network device;
1203: the remote UE changes a direct path according to the first indication information, such as initiating a random access procedure, which is similar to that in the related art, and shall not be repeated herein any further;
1204: initiating RRC reestablishment when the changing a direct path fails, and in a case where a suitable cell is found before T311 expires, transmitting an RRC reestablishment request via an indirect path.

In some embodiments, as shown in FIG. 12, the method further includes:
1200: deciding to change a direct path.

In the above embodiments, steps 1200 and 1202-1204 are similar to 1000 and 1003-1005 shown in FIG. 10, and step 1201 is similar to 901 shown in FIG. 9, which are incorporated herein, and shall not be repeated herein any further.

It should be noted that the cases where the network device and the remote UE communicate simultaneously via the direct path and the indirect path are not limited to the cases shown in FIGS. 11 and 12.

In addition, in the embodiments described in FIG. 10, in step 1001, the relay terminal equipment via which the network device transmits the first indication information and the relay terminal equipment via which the remote UE initiates RRC reestablishment may be identical or different, and FIG. 10 is illustrative only. For example, the previous configuration of the indirect path is used by the network device in transmitting the first indication information and the remote UE in transmitting the failure information, and the relay UEs in FIG. 10 are the relay UE on the previous indirect path. For example, when the network device transmits the first indication information, it uses the previous configuration of the indirect path, while the configuration used in transmitting the failure information is not the previous configuration of the indirect path. The relay UEs in FIG. 10 are two different relay UEs, and only one relay UE is illustrated in the figure for simplicity.

It can be seen from the above embodiments that in the scenario where the remote UE communicates with the network device via the direct path and the indirect path (as shown in FIG. 3), the remote terminal equipment initiates RRC reestablishment when changing a direct path fails, which solves problems existing in the related art. Hence, as behaviors of the remote terminal equipment when changing a direct path fails are specified, it is beneficial for the remote terminal equipment and the network device to have consistent understandings of the configuration of the remote terminal equipment, thereby avoiding configuration conflicts or mismatches.

### Embodiments of a Seventh Aspect

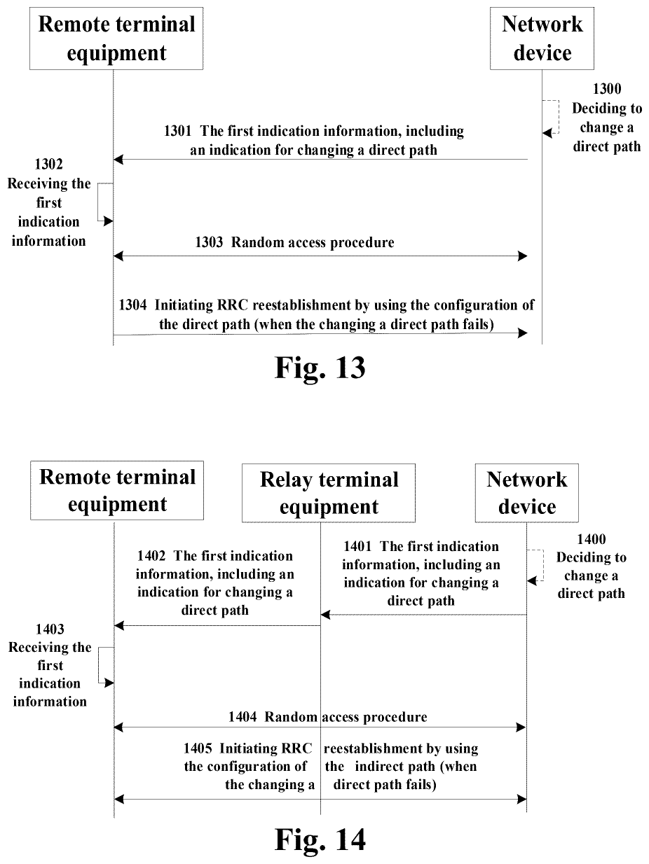

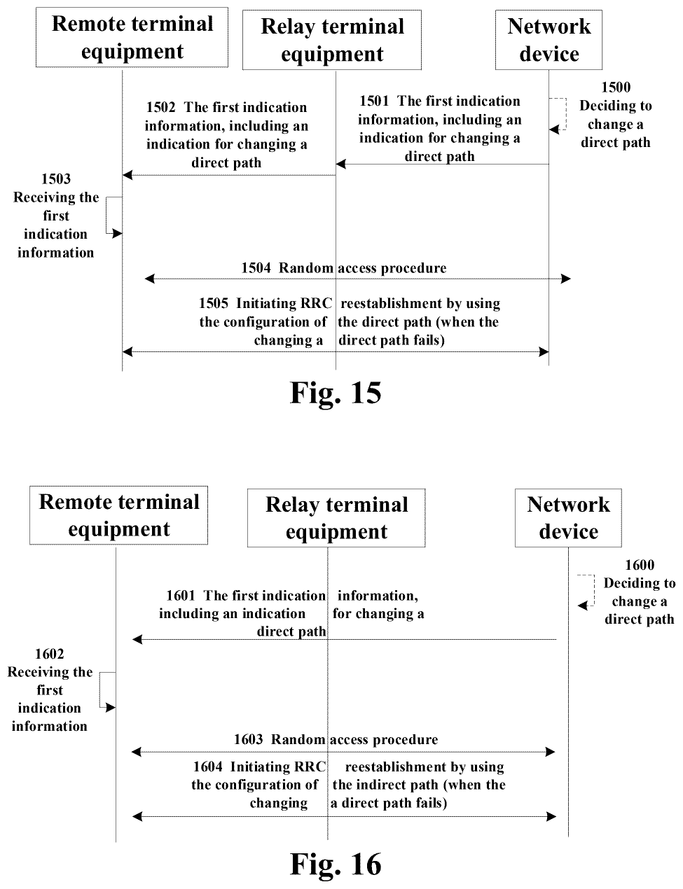

FIGS. 13-16 are schematic diagrams of the path processing methods of embodiments of this disclosure, which shall be described by taking a scenario where a remote UE communicates with a network device via a direct path and an indirect path (as shown in FIG. 3) as an example. FIG. 13 is a schematic diagram of communicating by the remote UE with the network device via a direct path throughout the entire procedure, FIG. 14 is a schematic diagram of communicating by the remote UE with the network device via an indirect path throughout the entire procedure, and FIGS. 15 and 16 are schematic diagrams of communicating by the remote UE with the network device simultaneously via a direct path and an indirect path.

In some embodiments, as shown in FIG. 13, in the case where the remote UE communicates with the network device via a direct path throughout the entire procedure, the method includes:
1301: the network device transmits the first indication information directly to the remote UE, the first indication information including an indication for changing a direct path;
for example, the first indication information may be transmitted via the direct path, such as via an RRC reconfiguration message;
1302: the remote UE receives the first indication information transmitted by the network device;
1303: the remote UE changes a direct path according to the first indication information;
for example, a random access procedure may be initiated, which is similar to that in the related art, and shall not be repeated herein any further; and if the random access procedure fails (such as random access is not successful when timer T304 expires), it indicates that the changing a direct path fails;
1304: transmitting failure information to the network device when the changing a direct path fails;
for example, the failure information may be transmitted via the previous configuration of a direct path or the configuration of a direct path in the default configuration.

In some embodiments, as shown in FIG. 13, the method further includes:
1300: deciding to change a direct path,
wherein the network device may decide to change a direct path according to a measurement report fed back by the remote UE, so as to transmit the first indication information. For example, the network device may transmit a measurement configuration message to the remote UE via a direct path and/or an indirect path, and the remote UE performs measurement based on the measurement configuration message, and feeds back measurement reporting via the direct path and/or the indirect path. Therefore, the network device may decide to change a direct path based on the measurement reporting.

In some embodiments, in 1304, the default configuration may be a predefined configuration or a specified configuration, and may include at least one of the following: configuration of a radio bearer, a security configuration, a configuration of an RLC bearer, an MAC configuration, a physical layer configuration, or an SRAP configuration, etc.

In some embodiments, as shown in FIG. 14, when the remote UE communicates with the network device via an indirect path throughout the entire procedure, the method includes:
1401: the network device transmits the first indication information to the remote UE via the relay UE, the first indication information including an indication for changing a direct path;
1402: the relay UE receives and forwarding the first indication information to the remote UE;
1403: the remote UE receives the first indication information transmitted by the network device via the relay UE;
1404: the remote UE changes direct path according to the first indication information, such as initiating a random access procedure, which is similar to that in the related art, and shall not be repeated herein any further;
1405: transmitting failure information to the network device when the changing a direct path fails;
for example, the failure information may be transmitted via the previous configuration of the indirect path, or the configuration of the indirect path in the default configuration, or the configuration of the indirect path indicated by the network device.

In some embodiments, as shown in FIG. 14, the method further includes:
1400: deciding to change a direct path.

In some embodiments, as shown in FIG. 15, when the remote UE communicates with the network device simultaneously via a direct path and an indirect path, for example, the network device transmits the first indication information via the indirect path, and the remote UE transmits the failure information via the direct path. The method includes:
1501: the network device transmits the first indication information to the remote UE via the relay UE, the first indication information including an indication for changing a direct path;
1502: the relay UE forwards the first indication information to the remote UE;
1503: the remote UE receives the first indication information transmitted by the network device via the relay UE;
1504: the remote UE changes a direct path according to the first indication information, such as initiating a random access procedure, which is similar to that in the related art, and shall not be repeated herein any further;
1505: transmitting the failure information to the network device when the changing a direct path fails;
for example, the failure information may be transmitted via the previous configuration of the direct path, or the configuration of the direct path in the default configuration.

In some embodiments, as shown in FIG. 15, the method further includes:
1500: deciding to change a direct path.

In some embodiments, as shown in FIG. 16, when the remote UE communicates with the network device simultaneously via a direct path and an indirect path, for example, the network device transmits the first indication information via the direct path, and the remote UE initiates RRC reestablishment via the indirect path. The method includes:
1601: the network device transmits the first indication information to the remote UE, the first indication information including an indication for changing a direct path;
1602: the remote UE receives the first indication information transmitted by the network device;
1603: the remote UE changes a direct path according to the first indication information, such as initiating a random access procedure, which is similar to that in the related art, and shall not be repeated herein any further;
1604: transmitting the failure information to the network device when the changing a direct path fails, such as transmitting the failure information via the previous configuration of the indirect path, or the configuration of the indirect path in the default configuration, or the configuration of the indirect path indicated by the network device.

In some embodiments, as shown in FIG. 16, the method further includes:
1600: deciding to change a direct path.

It should be noted that the cases where the network device and the remote UE communicate simultaneously via the direct path and the indirect path are not limited to the cases shown in FIGS. 15 and 16.

In addition, in the embodiments described in FIG. 14, in step 1401, the relay terminal equipment via which the network device transmits the first indication information and the relay terminal equipment via which the remote UE initiates RRC reestablishment may be identical or different, and FIG. 14 is illustrative only. For example, the previous configuration of the indirect path is used by the network device in transmitting the first indication information and the remote UE in transmitting the failure information, and the relay UEs in FIG. 14 are the relay UE on the previous indirect path. For example, when the network device transmits the first indication information, it uses the previous configuration of the indirect path, while the configuration used in transmitting the failure information is not the previous configuration of the indirect path. The relay UEs in FIG. 14 are two different relay UEs, and only one relay UE is illustrated in the figure for simplicity.

It can be seen from the above embodiments that in the scenario where the remote UE communicates with the network device via the direct path and the indirect path (as shown in FIG. 3), the remote terminal equipment transmits the failure information to the network device when changing a direct path fails, which solves problems existing in the related art. Hence, as behaviors of the remote terminal equipment when changing a direct path fails are specified, it is beneficial for the remote terminal equipment and the network device to have consistent understandings of the configuration of the remote terminal equipment, thereby avoiding configuration conflicts or mismatches.

### Embodiments of an Eighth Aspect

The embodiments of this disclosure provide a path processing method.

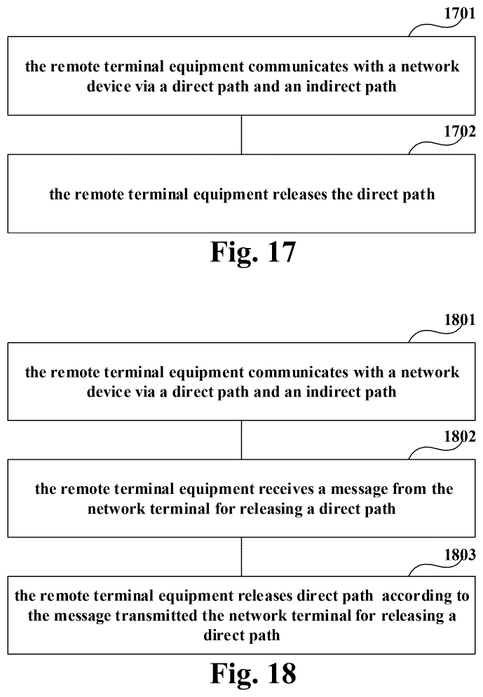

FIG. 17 is a schematic diagram of the path processing method of the embodiments of this disclosure. As shown in FIG. 17, the method is applicable to a and includes:
1701: the remote terminal equipment communicates with a network device via a direct path and an indirect path; and
1702: the remote terminal equipment releases the direct path,
wherein a primary cell (PCell) of the remote terminal equipment is a primary cell on the released direct path, or a primary cell of the remote terminal equipment is a serving cell of a relay terminal equipment on the indirect path.

According to the above embodiments, in multi-path operations, that is, when the remote UE communicates with the network device via multiple paths (a direct path and an indirect path), the remote terminal equipment releases the direct path. After releasing the direct path, its primary cell is a primary cell on the released direct path or a serving cell of the relay terminal equipment on the indirect path. Therefore, the primary cell of the remote UE when adding or changing a direct path fails is specified, which allows the remote UE to clearly identify the primary cell and facilitate execution of relevant operations on the primary cell. In addition, it is also beneficial for the remote UE and the network device to have consistent understandings of the configuration of the remote UE, thereby avoiding configuration conflicts or mismatches, and solving the above problems in existing in the related art.

It should be noted that FIG. 17 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 17.

In some embodiments, the remote terminal equipment communicates with the network device via the direct path and the indirect path, and releases the direct path, and the primary cell (PCell) of the remote terminal equipment is a primary cell on the released direct path.

For example, the remote terminal equipment communicates with the network device via the direct path and the indirect path, wherein the PCell in the direct path is cell 1, the PCell in the relay terminal equipment in the indirect path is cell 2, and the PCell in the remote terminal equipment is cell 1. After the direct path is released, the PCell of the remote terminal equipment is still cell 1.

In some embodiments, the remote terminal equipment communicates with the network device via the direct path and the indirect path, and releases the direct path, and the primary cell (PCell) of the remote terminal equipment is the serving cell of the relay terminal equipment on the indirect path.

In some embodiments, the serving cell of the relay terminal equipment includes a primary cell (PCell) or a secondary cell (SCell) or a primary SCG cell (PSCell) or a serving cell of the relay terminal equipment.

For example, the remote terminal equipment communicates with the network device via the direct path and the indirect path, wherein the PCell in the direct path is cell 1, the PCell of the relay terminal equipment of the indirect path is cell 2, two SCells of the relay terminal equipment of the indirect path are cell 3 and cell 4, and the PSCell of the relay terminal equipment of the indirect path is cell 5. After the direct path is released, the PCell of the remote terminal equipment may be the PCell (cell 2) of the relay terminal equipment, or the SCell (cell 3 or cell 4) of the relay terminal equipment, or the PSCell (cell 5) of the relay terminal equipment, or one of serving cells (one of cell 2˜cell 5) of the relay terminal equipment.

In the above embodiments, the primary cell of the remote UE when adding or changing a direct path fails is specified, which allows the remote UE to clearly identify the primary cell and facilitate execution of relevant operations on the primary cell. In addition, it is also beneficial for the remote UE and the network device to have consistent understandings of the configuration of the remote UE, thereby avoiding configuration conflicts or mismatches, and solving the above problems in existing in the related art.

### Embodiments of a Ninth Aspect

The embodiments of this disclosure provide a path processing method. FIG. 18 is a schematic diagram of the path processing method of the embodiments of this disclosure. As shown in FIG. 18, the method is applicable to a remote terminal equipment and includes steps 1801, 1802 and 1803.
1801: the remote terminal equipment communicates with a network device via a direct path and an indirect path,
wherein 1801 is similar to 1701 in FIG. 17, and shall not be repeated herein any further;
1802: the remote terminal equipment receives a message from the network terminal for releasing a direct path;
in some embodiments, as the remote terminal equipment communicates with the network device via the direct path and the indirect path in 1801, thus in 1802, the remote terminal equipment receives via the direct path and the indirect path the message from the network terminal for releasing a direct path;
1803: the remote terminal equipment releases direct path according to the message transmitted the network terminal for releasing a direct path,
wherein a primary cell (PCell) of the remote terminal equipment is a primary cell on the released direct path, or, a primary cell of the remote terminal equipment is a serving cell of the relay terminal equipment on the indirect path.

It can be seen from the above embodiments that the remote UE may release a direct path according to the request message transmitted by the network device, and identify a primary cell in the above method after releasing the direct path, which facilitates execution of relevant operations on the primary cell. In addition, it is also beneficial for the remote UE and the network device to have consistent understandings of the configuration of the remote UE, thereby avoiding configuration conflicts or mismatches, and solving the above problems in the related art.

In some embodiments, the primary cell on the direct path and the serving cell of the relay UE on the indirect path are as described in the embodiments of the eighth aspect, the contents of which being incorporated herein, and shall not be repeated herein any further.

In some embodiments, the message transmitted by the network device for releasing a direct path includes the configuration of the indirect path.

In the embodiments, an existing path switch procedure is used to release the direct path, in which case the message for releasing a direct path is an RRC reconfiguration message transmitted by the network device, the RRC reconfiguration message including the configuration of the indirect path.

In the embodiments, the message for releasing a direct path may include only the configuration of the indirect path.

In the embodiments, the RRC configuration message may include only the configuration of indirect path.

In the above embodiments, a path switch procedure is used for the direct path release and update of the primary cell of the remote UE. When the message for releasing a direct path or the RRC configuration message includes only the configuration of the indirect path, a direct path is no longer explicitly released, thereby reducing signaling overhead.

According to the above embodiments, in multi-path operations, after the remote terminal equipment releases the direct path, its primary cell is a primary cell on the released direct path or a serving cell of the relay terminal equipment on the indirect path. Therefore, the primary cell of the remote terminal equipment when adding or changing a direct path fails is specified, which allows the remote UE to clearly identify the primary cell and facilitate execution of relevant operations on the primary cell. In addition, it is also beneficial for the remote UE and the network device to have consistent understandings of the configuration of the remote UE, thereby avoiding configuration conflicts or mismatches, and solving the above problems in existing in the related art.

### Embodiments of a Tenth Aspect

This disclosure provides a path processing method.

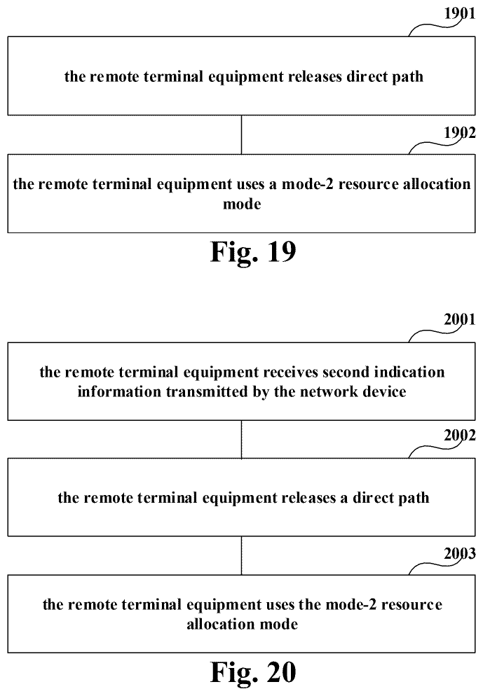

FIG. 19 is a schematic diagram of the path processing method of the embodiments of this disclosure. As shown in FIG. 19, this method is applicable to a remote terminal equipment, the remote terminal equipment communicating with a network device by using a direct path and an indirect path in a mode-1 resource allocation mode. The method includes:
1901: the remote terminal equipment releases direct path; and
1902: the remote terminal equipment uses a mode-2 resource allocation mode.

According to the above embodiments, in multi-path operations, the remote terminal equipment using the mode-1 resource allocation mode releases a direct path and uses the mode-2 resource allocation mode. Therefore, after the remote terminal equipment using the mode-1 resource allocation mode in multi-path operations releases a direct path, its indirect path may use the mode-2 resource allocation mode for operation, thereby avoiding the problem that the remote terminal equipment using the mode-1 resource allocation mode and the network device are unable to communicate after the direct path is released.

It should be noted that FIG. 19 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 19.

When the remote terminal equipment communicates with the network device by using the direct path and the indirect path (such as in the scenario shown in FIG. 3) and uses the mode-2 resource allocation mode, the remote terminal equipment releases the direct path, without needing to switch a sidelink mode, and operates by still using the mode-2 resource allocation mode.

In the embodiments, the mode-1 resource allocation mode is a sidelink resource allocation mode scheduled by the network, and the mode-2 resource allocation mode is a sidelink resource allocation mode in which the terminal equipment autonomously selects resources, and reference may be made to definitions in existing standards.

In some embodiments, in 1902, the remote terminal equipment may autonomously switch the mode-1 resource allocation mode to the mode-2 resource allocation mode.

For example, after releasing the direct path, the remote terminal equipment autonomously switches to the mode-2 resource allocation mode, and operates by using the mode-2 resource allocation mode.

In some embodiments, the path processing method further includes (not shown in figures): communicating with the relay terminal equipment by using preconfigured resource pool configuration information or resource pool configuration information in system information of a serving cell of the relay UE on the indirect path.

In some embodiments, in a case where system information related to sidelink discovery and/or communication of the serving cell of the relay terminal equipment on the indirect path appears, when the remote terminal equipment autonomously switches to the mode-2 resource allocation mode, the resource pool configuration information in the system information (e.g. SIB 12) of the serving cell of the relay UE may be used to communicate with the relay terminal equipment.

In some embodiments, when the remote terminal equipment autonomously switches to the mode-2 resource allocation mode, preconfigured resource pool configuration information may be used to communicate with the relay terminal equipment, that is, the resource pool configuration information is from preconfiguration of the remote terminal equipment, and reference may be made to existing standards for a definition of the preconfiguration.

In some embodiments, the remote terminal equipment uses preconfigured resource pool configuration information when it does not acquire the system information related to sidelink discovery and/or communication of the serving cell of the relay terminal equipment; or, the remote terminal equipments uses the resource pool configuration information in the system information of the serving cell of the relay UE on the indirect path when there is no preconfigured resource pool configuration information.

In some embodiments, the method further includes (not shown in figures): transmitting a resource pool configuration information request by the remote terminal equipment to the network device.

For example, the resource pool configuration information request is included in a sidelink UE information message.

A time for transmitting the request may be arbitrary. For example, when the remote terminal equipment autonomously switches to the mode-2 resource allocation mode, it may transmit a resource pool configuration information request to the network device.

For another example, the remote terminal equipment may initiate a resource pool configuration information request to the network device when it does not acquire the resource configuration information in the system information of the serving cell of the relay UE and/or there is no preconfigured resource pool information.

For a further example, when the remote terminal equipment does not acquire the resource pool configuration information in the system information of the serving cell of the relay UE, it initiates a resource pool configuration information request to the network device; or, the remote terminal equipment initiates a resource pool configuration information request to the network device when there is no preconfigured resource pool configuration information; or, the remote terminal initiates a resource pool configuration information request to the network device when the remote terminal equipment does not acquire the resource pool configuration information in the system information of the serving cell of the relay UE and there is no preconfigured resource pool configuration information.

In some embodiments, the method further includes (not shown in figures): receiving a message from the network device for releasing a direct path.

In this case, in 1901, the remote UE releases a direct path according to the message.

According to the above embodiments, in multi-path operations, the remote terminal equipment using the mode-1 resource allocation mode releases a direct path and autonomously switches to using the mode-2 resource allocation mode. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

### Embodiments of an Eleventh Aspect

This disclosure provides a path processing method.

FIG. 20 is a schematic diagram of the path processing method of the embodiments of this disclosure. As shown in FIG. 20, this method is applicable to a remote terminal equipment, the remote terminal equipment communicating with a network device by using a direct path and an indirect path in a mode-1 resource allocation mode. The method includes:
2001: the remote terminal equipment receives second indication information transmitted by the network device, the second indication information including information indicating that the remote terminal equipment uses the mode-2 resource allocation mode;
2002: the remote terminal equipment releases a direct path; and
2003: the remote terminal equipment uses the mode-2 resource allocation mode.

In this case, in 2003, the remote UE uses the mode-2 resource allocation mode according to the second indication information.

According to the above embodiments, in multi-path operations, in case of releasing a direct path, the remote terminal equipment using the mode-1 resource allocation mode uses the mode-2 resource allocation mode according to an instruction of the network device. Therefore, after the remote terminal equipment using the mode-1 resource allocation mode in multi-path operations releases a direct path, its indirect path may use the mode-2 resource allocation mode for operation, thereby avoiding the problem that the remote terminal equipment and the network device are unable to communicate after the direct path is released.

When the remote terminal equipment communicates with the network device by using the direct path and the indirect path (such as in the scenario shown in FIG. 3) and uses the mode-2 resource allocation mode, the remote terminal equipment releases the direct path, without needing to switch a sidelink mode, and operates by still using the mode-2 resource allocation mode.

In the embodiments, reference may be made to the above description for explanations of the mode-1 resource allocation mode and the mode-2 resource allocation mode.

It should be noted that FIG. 20 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 20.

In some embodiments, the second indication information is an RRC reconfiguration message fed back by the network device according to the sidelink user equipment information message.

In some embodiments, the method further includes (not shown in figures):
communicating with the relay terminal equipment by using preconfigured resource pool configuration information or resource pool configuration information in the system information of the serving cell of the relay UE on the indirect path, reference may be made to the embodiments of the tenth aspect for details.

In some embodiments, the method further includes (not shown in figures):
initiating a resource pool configuration information request by the remote terminal equipment to the network device.

For example, the resource pool configuration information request is included in the sidelink UE information message.

In some embodiments, the second indication information transmitted by the network device further includes resource pool configuration information.

In this case, when the remote terminal equipment uses the mode-2 resource allocation mode according to the second indication information of the network device, the method further includes (not shown in figures):
communicating with the relay terminal equipment by using the resource pool configuration information included in the second indication information.

In some embodiments, the method further includes the following steps (not shown in figures):
receiving a message from network devices for releasing a direct path; and
releasing a direct path according to the message,
wherein the remote UE receives the message for releasing a direct path via a direct path and/or an indirect path.

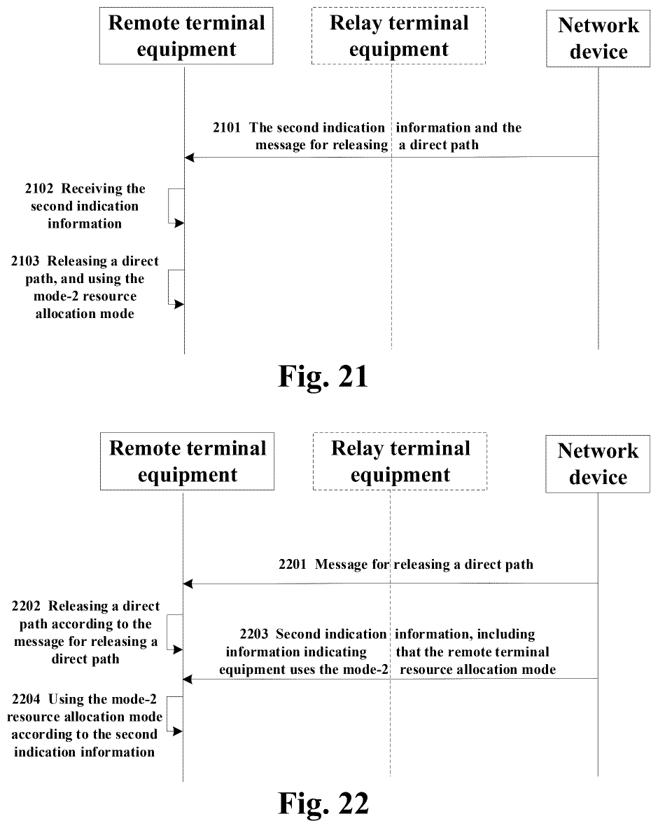

FIG. 21 is a flowchart of information exchange between the remote UE and the network device, wherein the remote UE first receives the second indication information, and then releases a direct path. As shown in FIG. 21:
2101: the network device transmits second indication information and a message for releasing a direct path to the remote UE, the second indication information including information indicating that the remote terminal equipment uses the mode-2 resource allocation mode and a message for releasing a direct path,
wherein the network device may transmit the second indication information and the message for releasing a direct path to the remote UE via a direct path and/or an indirect path, and may also transmit the message for releasing a direct path and the second indication information respectively to the remote UE;
2102: the remote UE receives the second indication information; and
2103: the remote UE releases a direct path according to the message for releasing a direct path in the second indication information, and uses the mode-2 resource allocation mode according to information indicating that the remote terminal uses the mode-2 resource allocation mode.

FIG. 22 is another flowchart of information exchange between the remote UE and the network device. As shown in FIG. 22:
2201: the network device transmits a message for releasing a direct path to the remote UE,
wherein the network device may transmit the message for releasing a direct path to the remote UE via a direct path and/or an indirect path;
2202: the remote UE receives the message for releasing a direct path and releases a direct path according to the message;
2203: the network device transmits the second indication information to the remote UE, the second indication information including information indicating that the remote terminal equipment uses the mode-2 resource allocation mode,
wherein the network device may transmit the second indication information to the remote UE via an indirect path; and
2204: the remote UE receives the second indication information and uses the mode-2 resource allocation mode according to the second indication information.

According to the above embodiments, in multi-path operations, the remote terminal equipment using the mode-1 resource allocation mode releases a direct path and switches to using the mode-2 resource allocation mode according to the indication of the network device. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

### Embodiments of a Twelfth Aspect

This disclosure provides a path processing method.

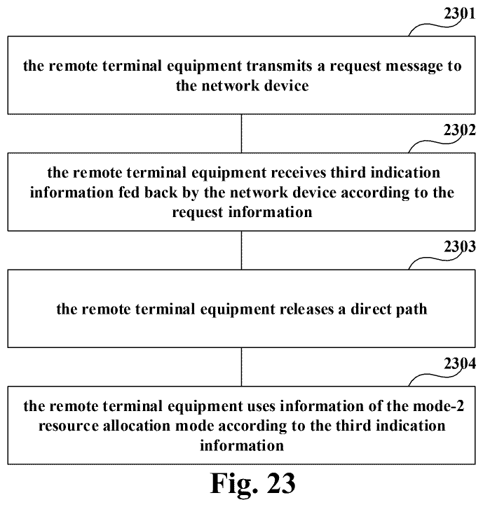

FIG. 23 is a schematic diagram of the path processing method of the embodiments of this disclosure. As shown in FIG. 23, this method is applicable to a remote terminal equipment, the remote terminal equipment communicating with a network device by using a direct path and an indirect path in a mode-1 resource allocation mode. The method includes:
2301: the remote terminal equipment transmits a request message to the network device;
2302: the remote terminal equipment receives third indication information fed back by the network device according to the request information, the third indication information including information indicating that the remote UE uses a mode-2 resource allocation mode;
2303: the remote terminal equipment releases a direct path;
2304: in a case of releasing a direct path, the remote terminal equipment uses information of the mode-2 resource allocation mode according to the third indication information.

According to the above embodiments, in multi-path operations, the remote terminal equipments using the mode-1 resource allocation mode uses the mode-2 resource allocation mode according to the indication of the network device when a direct path is released. Therefore, after the remote terminal equipment using the mode-1 resource allocation mode in multi-path operations releases a direct path, its indirect path may use the mode-2 resource allocation mode for operation, thereby avoiding the problem that the remote terminal equipment using the mode-1 resource allocation mode and the network device are unable to communicate after the direct path is released.

When the remote terminal equipment communicates with the network device by using a direct path and an indirect path (such as in the scenario shown in FIG. 3) and uses the mode-2 resource allocation mode, the remote terminal equipment releases the direct path, without needing to switch a sidelink mode, and operates by still using the mode-2 resource allocation mode.

In the embodiments, reference may be made to the above description for explanations of the mode-1 resource allocation mode and the mode-2 resource allocation mode.

It should be noted that FIG. 23 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 23.

In the embodiments, in 2301, the request message transmitted by the remote UE to the network device is a sidelink UE information message;
and in 2302, the third indication information fed back by the network device according to the sidelink UE information message is received.

In some embodiments, the third indication information is an RRC reconfiguration message fed back by the network device according to the sidelink UE information message.

In some embodiments, the method further includes (not shown in figures):
communicating with a relay terminal equipment by using preconfigured resource pool configuration information or resource pool configuration information in system information of a serving cell of the relay UE on the indirect path.

For example, the preconfigured resource pool configuration information is from preconfiguration of the remote UE, and reference may be made to existing standards for a definition of the preconfiguration.

The resource pool configuration information in the system information of the serving cell of the relay UE on the indirect path may be resource pool configuration information in system information (e.g. SIB 12) related to sidelink discovery and/or communication of the serving cell of the relay UE on the indirect path.

In some embodiments, the method further includes (not shown in figures):
initiating a resource pool configuration information request by the remote terminal equipment to the network device.

For example, the resource pool configuration information request is included in the sidelink UE information message.

In some embodiments, the third indication information further includes resource pool configuration information.

In this case, the remote terminal equipment may communicate with the network device by using the resource pool configuration information in the third indication information.

In some embodiments, the above resource pool configuration information includes information on a sidelink transmission resource pool and/or information on a sidelink reception resource pool, and reference may be made to existing standards for details.

In some embodiments, the method further includes the following steps (not shown in figures):
receiving a message from network devices for releasing a direct path; and
releasing a direct path according to the message,
wherein the remote UE receives the message for releasing a direct path via a direct path and/or an indirect path.

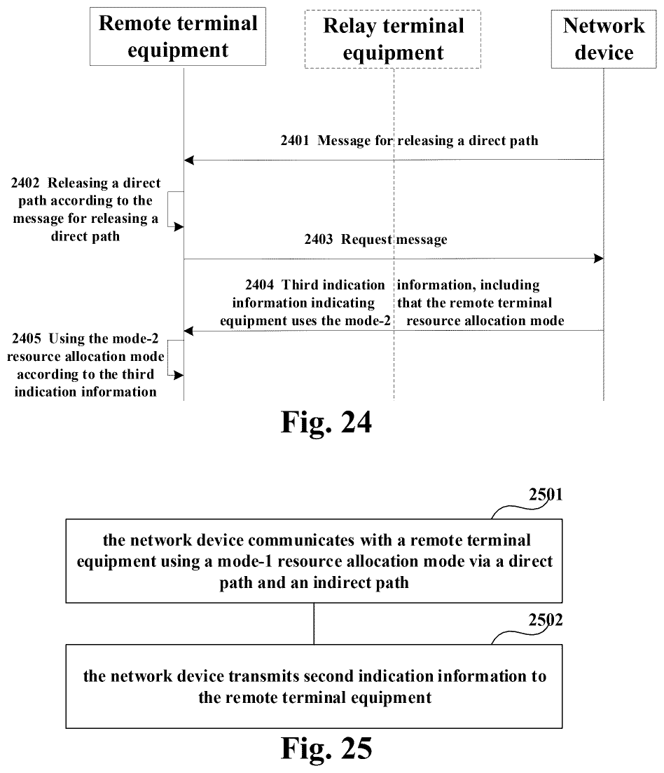

FIG. 24 is a flowchart of information exchange between the remote UE and the network device. As shown in FIG. 24:
2401: the network device transmits a message for releasing a direct path to the remote UE;
2402: the remote UE receives the message for releasing a direct path, and releases a direct path according to the message;
2403: the remote UE transmits a request message to the network device;
2404: the network device transmits a third indication information according to the request message, the third indication information including information indicating that the remote terminal equipment uses the mode-2 resource allocation mode; and
2405: the remote UE receives the third indication information and uses the mode-2 resource allocation mode according to the third indication information.

According to the above embodiments, in multi-path operations, the remote terminal equipment using the mode-1 resource allocation mode releases a direct path and autonomously request the network device for switching to using the mode-2 resource allocation mode. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

### Embodiments of a Thirteenth Aspect

This disclosure provides a path processing method.

FIG. 25 is a schematic diagram of the path processing method of the embodiments of this disclosure. As shown in FIG. 25, the method is applicable to a network device and includes:
2501: the network device communicates with a remote terminal equipment using a mode-1 resource allocation mode via a direct path and an indirect path; and
2502: the network device transmits second indication information to the remote terminal equipment, the second indication information including information indicating that the remote terminal equipment uses a mode-2 resource allocation mode in case of releasing a direct path.

According to the above embodiments, in multi-path operations, the network device transmits the second indication information to the remote terminal equipment using the mode-1 resource allocation mode via a direct path and/or an indirect path, indicating that the remote terminal equipment uses the mode-2 resource allocation mode in case of releasing a direct path, so that the remote terminal equipment switches the mode-1 resource allocation mode to the mode-2 resource allocation mode based on the second indication information in case of releasing a direct path. Therefore, after the remote terminal equipment using the mode-1 resource allocation mode in multi-path operations releases a direct path, its indirect path may use the mode-2 resource allocation mode for operation, thereby avoiding the problem that the remote terminal equipment using the mode-1 resource allocation mode and the network device are unable to communicate after the direct path is released.

It should be noted that FIG. 25 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 25.

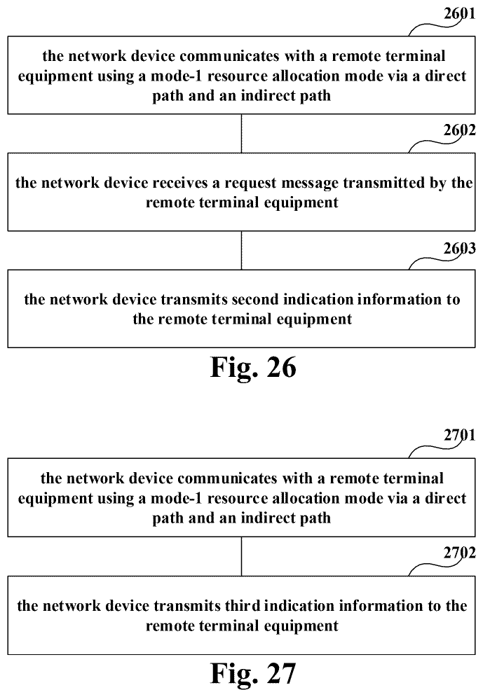

In some embodiments, FIG. 26 is a schematic diagram of the path processing method of the embodiments of this disclosure. As shown in FIG. 26, the method includes steps 2601, 2602 and 2603, wherein 2601 and 2603 are respectively similar to 2501 and 2502 in FIG. 25, identical contents shall not be repeated herein any further, and different contents shall be explained in detail. As shown in FIG. 26, the method includes:
2602: the network device receives a request message transmitted by the remote terminal equipment.

In this case, in 2603, the network device transmits the second indication information to the remote terminal equipment according to the request message.

In some embodiments, the request message transmitted by the remote terminal equipment received in 2602 is a sidelink UE information message; in this case, in 2603, the network device transmits the second indication information to the remote terminal equipment according to the sidelink UE information message.

According to the above embodiments, in multi-path operations, the remote terminal equipment using the mode-1 resource allocation mode releases a direct path and autonomously switches to using the mode-2 resource allocation mode. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

### Embodiments of a Fourteenth Aspect

FIG. 27 is a schematic diagram of the path processing method of the embodiments of this disclosure. As shown in FIG. 27, the method is applicable to a network device and includes:
2701: the network device communicates with a remote terminal equipment using a mode-1 resource allocation mode via a direct path and an indirect path;
2702: the network device transmits third indication information to the remote terminal equipment, the third indication information including information indicating to release a direct path and information indicating to use a mode-2 resource allocation mode in a case of releasing a direct path.

According to the above embodiments, in multi-path operations, the network device transmits the third indication information to the remote terminal equipment using the mode-1 resource allocation mode via a direct path and/or an indirect path, so that the remote terminal equipment releases a direct path according to the third indication information and uses the mode-2 resource allocation mode in case of releasing a direct path. Therefore, after the remote terminal equipment using the mode-1 resource allocation mode in multi-path operations releases a direct path, its indirect path may use the mode-2 resource allocation mode for operation, thereby avoiding the problem that the remote terminal equipment and the network device are unable to communicate after the direct path is released.

It should be noted that FIG. 27 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 27.

According to the above embodiments, in multi-path operations, the remote terminal equipment using the mode-1 resource allocation mode releases a direct path and switches to using the mode-2 resource allocation mode. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

### Embodiments of a Fifteenth Aspect

The embodiments of this disclosure provide a path processing apparatus. The apparatus may be, for example, a remote terminal equipment, or may be one or some components or assemblies configured in the remote terminal equipment. The embodiments correspond to the embodiments of the first aspect, and contents identical to those in the embodiments of the first aspect shall not be described herein any further.

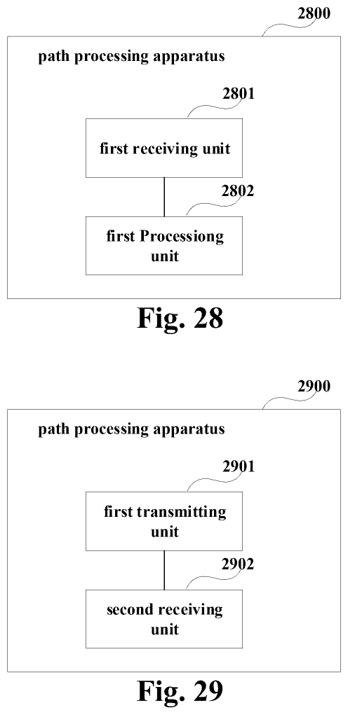

FIG. 28 is a schematic diagram of the path processing apparatus of the embodiments of this disclosure. As shown in FIG. 28, a path processing apparatus 2800 includes:
a first receiving unit 2801 configured to receive first indication information transmitted by a network device, the first indication information including an indication for adding or changing a direct path; and
a first processing unit 2802 configured to initiate RRC reestablishment or transmit failure information to the network device when a direct path is added or changed according to the first indication information and the adding or changing a direct path fails.

According to the above embodiments, the remote terminal equipment may initiate RRC reestablishment or transmit failure information to the network device when the remote UE adds or changes a direct path according to the indication of the network device and the adding or changing the direct path fails. Hence, operations of the remote UE when adding a direct path or changing the direct path fails are regulated, which solves the problem in the related art, and is beneficial for the remote UE and the network device to have a consistent understanding of the configuration of the remote UE, and configuration conflicts or mismatches are avoided.

In the embodiments, the first processing unit 2802 initiates RRC reestablishment or transmits the failure information to the network device by using a configuration before receiving the first indication information or a default configuration.

For example, in the case where the first indication information includes an indication for adding a direct path, the configuration before receiving the first indication information includes: a configuration in communicating with the network device by using an indirect path;
and in the case where the first indication information includes an indication for changing a direct path, the configuration before receiving the first indication information includes: a configuration in communicating with the network device by using a direct path and/or an indirect path.

In addition, the default configuration is as described in the embodiments of the first aspect, and shall not be repeated herein any further.

In the embodiments, the first receiving unit 2801 is further configured to receive configuration information, the configuration information including configuration of an indirect path;
and the first processing unit 2802 initiates RRC reestablishment or transmits the failure information to the network device by using the configuration of an indirect path.

In some embodiments, the configuration information may be included in the first indication information and transmitted to the remote UE together with the first indication information; in addition, it may also be transmitted separately to the remote UE, which is not limited in the embodiments.

In the embodiments, the first processing unit 2802 is configured to initiate cell selection or relay terminal equipment selection in a case where an RRC reestablishment procedure is initiated. A specific RRC reestablishment procedure is as described in the embodiments of the first aspect, which shall not be repeated herein any further.

In the embodiments, the transmitting failure information to the network device by the first processing unit in the case where the first indication information includes an indication for adding a direct path includes: transmitting the failure information to the network device via an indirect path. A specific procedure for transmitting the failure information is as described in the embodiments of the first aspect, which shall not be repeated herein any further.

In the embodiments, the first processing unit communicates with the network device by using a configuration of the indirect path before the first indication information is received or a configuration of the indirect path in the default configuration.

In the embodiments, the first receiving unit 2801 is further configured to receive configuration information, the configuration information including the configuration of the indirect path;
and the first processing unit 2802 communicates with the network device by using the configuration of the indirect path.

In the embodiments, that the first processing unit 2802 transmits the failure information to the network device in the case where the first indication information includes an indication for changing a direct path includes: transmitting the failure information to the network device via a direct path and/or an indirect path.

In the embodiments, the first processing unit communicates with the network device by using a configuration of a direct path and/or an indirect path before receiving the first indication information
or, communicates with the network device by using a configuration of a direct path and/or an indirect path in the default configuration.

In addition, the default configuration is as described in the embodiments of the first aspect, which shall not be repeated herein any further.

In the embodiments, the first indication information further includes a configuration of an indirect path;
and the first processing unit communicates with the network device by using the configuration of an indirect path included in the first indication information.

In the embodiments, the failure information includes a cause for failure.

In the embodiments, the cause for failure includes at least one of the following: failure in adding a direct path, failure in random access, failure in changing a direct path, or expiration of T304.

In the embodiments, the failure information is transmitted via an RRC message or an indication message of a lower layer.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the path processing apparatus 2800 may further include other components or modules, and reference may be made to related techniques for particulars of these components or modules.

Furthermore, for the sake of simplicity, connection relationships between the components or modules or signal profiles thereof are only illustrated in FIG. 28. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the remote UE may initiate RRC reestablishment or transmit failure information to the network device when the remote UE adds or changes a direct path according to the indication of the network device and adding or changing a direct path fails. Hence, as behaviors of the remote terminal equipment when adding or changing a direct path fails are specified, the problems in the related art are solved, which is beneficial for the remote terminal equipment and the network device to have consistent understandings of the configuration of the remote terminal equipment, thereby avoiding configuration conflicts or mismatches.

### Embodiments of a Sixteenth Aspect

The embodiments of this disclosure provide a path processing apparatus. The apparatus may be, for example, a network device, or may be one or some components or assemblies configured in the network device. The embodiments correspond to the embodiments of the second aspect, and contents identical to those in the embodiments of the second aspect shall not be described herein any further.

FIG. 29 is a schematic diagram of the path processing apparatus of the embodiments of this disclosure. As shown in FIG. 29, a path processing apparatus 2900 includes:
a first transmitting unit 2901 configured to transmit first indication information to a remote terminal equipment, the first indication information including an indication for adding or changing a direct path; and
a second receiving unit 2902 configured to receive an RRC reestablishment request message or failure information transmitted by the remote terminal equipment in adding or changing a direct path according to the first indication information and the adding or changing a direct path fails.

According to the above embodiments, the network device receives the RRC reestablishment message or failure information transmitted by the remote terminal equipment when adding or changing a direct path fails, and behaviors of the remote terminal equipment when adding or changing a direct path fails are specified, which is beneficial for the remote terminal equipment and the network device to have consistent understandings of the configuration of the remote terminal equipment, thereby avoiding configuration conflicts or mismatches.

In the embodiments, the second receiving unit 2902 is configured to,
in a case where the first indication information includes an indication for adding a direct path, receive via an indirect path the RRC reestablishment request message or failure information transmitted by the remote terminal equipment in adding a direct path according to the first indication information and the adding a direct path fails,
and in a case where the first indication information includes an indication for changing a direct path, receive via a direct path and/or an indirect path the RRC reestablishment request message or failure information transmitted by the remote terminal equipment in changing a direct path according to the first indication information and the changing a direct path fails.

In the embodiments, the second receiving unit 2902 is further configured to receive the RRC reestablishment request message or failure information by using a configuration before the remote terminal equipment receives the first indication information or a default configuration.

In the embodiments, the first transmitting unit 2901 is further configured to transmit configuration information to the remote terminal equipment, the configuration information including a configuration of an indirect path;
and the second receiving unit 2902 is further configured to receive the RRC reestablishment request message or failure information by using the configuration of the indirect path, wherein transmission of the configuration information is as described in the embodiments of the second aspect, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the path processing apparatus 2900 may further include other components or modules, and reference may be made to related techniques for particulars of these components or modules.

Furthermore, for the sake of simplicity, connection relationships between the components or modules or signal profiles thereof are only illustrated in FIG. 29. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the network device receives the RRC reestablishment message or failure information transmitted by the remote terminal equipment when adding or changing a direct path fails, and behaviors of the remote terminal equipment when adding or changing a direct path fails are specified, which is beneficial for the remote terminal equipment and the network device to have consistent understandings of the configuration of the remote terminal equipment, thereby avoiding configuration conflicts or mismatches.

### Embodiments of a Seventeenth Aspect

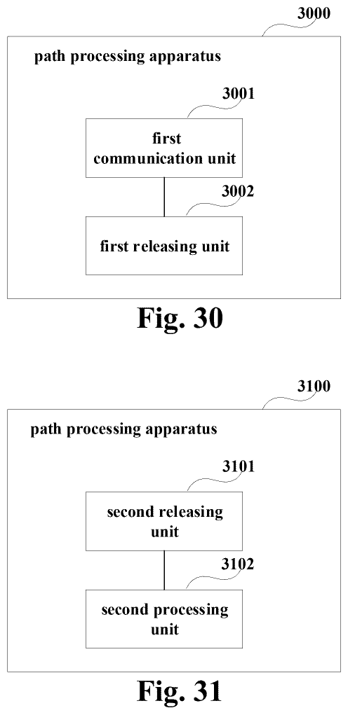

The embodiments of this disclosure provide a path processing apparatus. The apparatus may be, for example, a remote terminal equipment, or may be one or some components or assemblies configured in the remote terminal equipment. The embodiments correspond to the embodiments of the eighth and/or ninth aspect(s), and identical contents shall not be described herein any further. FIG. 30 is a schematic diagram of the path processing apparatus of the embodiments of this disclosure. As shown in FIG. 30, a path processing apparatus 3000 includes:
a first communication unit 3001 configured to communicate with a network device via a direct path and an indirect path; and
a first releasing unit 3002 configured to release the direct path,
wherein a primary cell (PCell) of the remote terminal equipment is a primary cell on the released direct path, or a primary cell of the remote terminal equipment is a serving cell of a relay terminal equipment on the indirect path.

According to the above embodiments, in multi-path operations, after the remote terminal equipment releases the direct path, its primary cell is a primary cell on the released direct path or a serving cell of the relay terminal equipment on the indirect path. Therefore, for the primary cell of the remote UE after the direct path is released, the remote UE and the network device may have consistent understandings of the configuration of the remote UE, thereby avoiding configuration conflicts or mismatches, and solving the above problems in existing in the related art.

In the embodiments, the serving cell of the relay terminal equipment includes a primary cell (PCell) or a secondary cell (SCell) or a primary SCG cell (PSCell) of the relay terminal equipment. In the embodiments, the first communication unit 3001 is configured to receive a message transmitted by the network device for releasing the direct path, the message including a configuration of the indirect path;
and the first releasing unit 3002 is configured to release the direct path according to the message for releasing the direct path.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the path processing apparatus 3000 may further include other components or modules, and reference may be made to related techniques for particulars of these components or modules.

Furthermore, for the sake of simplicity, connection relationships between the components or modules or signal profiles thereof are only illustrated in FIG. 30. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

According to the above embodiments, in multi-path operations, after the remote terminal equipment releases the direct path, its primary cell is a primary cell on the released direct path or a serving cell of the relay terminal equipment on the indirect path. Therefore, for the primary cell of the remote UE after the direct path is released, the remote UE and the network device may have consistent understandings of the configuration of the remote UE, thereby avoiding configuration conflicts or mismatches, and solving the above problems in existing in the related art.

### Embodiments of an Eighteenth Aspect

The embodiments of this disclosure provide a path processing apparatus. The apparatus may be, for example, a remote terminal equipment, or may be one or some components or assemblies configured in the remote terminal equipment. The embodiments correspond to the embodiments of the tenth and/or eleventh and/or twelfth aspect(s), and identical contents shall not be described herein any further.

FIG. 31 is a schematic diagram of the path processing apparatus of the embodiments of this disclosure. As shown in FIG. 31, the remote terminal equipment communicates with a network device by using a direct path and an indirect path and uses a mode-1 resource allocation mode, and a path processing apparatus 3100 includes:
the remote terminal equipment communicates with a network device by using a direct path and an indirect path and uses a mode-1 resource allocation mode,
a second releasing unit 3101 configured to release a direct path in a case communicating with a network device by using a direct path and an indirect path and using a mode-1 resource allocation mode; and
a second processing unit 3102 configured to use a mode-2 resource allocation mode.

According to the above embodiments, in multi-path operations, the remote terminal equipment using the mode-1 resource allocation mode releases a direct path and uses the mode-2 resource allocation mode. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

In the embodiments, the second processing unit 3002 is configured to autonomously switches the mode-1 resource allocation mode to the mode-2 resource allocation mode.

In the embodiments, the apparatus 3000 further includes a second communication unit (not shown in figures) configured to communicate with a relay terminal equipment by using preconfigured resource pool configuration information or resource pool configuration information in system information of a serving cell of a relay terminal equipment (relay UE) on the indirect path.

In the embodiments, the apparatus 3000 further includes:
a third receiving unit (not shown in figures) configured to receive second indication information transmitted by the network device, the second indication information including information indicating that the remote terminal equipment uses the mode-2 resource allocation mode;
and the second processing unit 3002 is configured to use the mode-2 resource allocation mode according to the second indication information.

In the embodiments, the second indication information further includes resource pool configuration information.

In the embodiments, the apparatus 3000 further includes a third communication unit (not shown in figures) configured to communicate with the relay terminal equipment by using the resource pool configuration information included in the second indication information.

In the embodiments, the apparatus 3000 further includes:
a fourth receiving unit (not shown in figures) configured to receive a message for releasing a direct path transmitted by the network device,
and the second releasing unit 3001 is configured to release a direct path according to the message for releasing a direct path.

In the embodiments, the second indication information is included in the message for releasing a direct path.

In the embodiments, the apparatus 3000 further includes a second transmitting unit (not shown in figures) configured to transmit a sidelink UE information message to the network device before receiving the second indication information;
and the third receiving unit receives the second indication information fed back by the network device according to the sidelink UE information message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the path processing apparatus 3100 may further include other components or modules, and reference may be made to related techniques for particulars of these components or modules.

Furthermore, for the sake of simplicity, connection relationships between the components or modules or signal profiles thereof are only illustrated in FIG. 31. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

According to the above embodiments, in multi-path operations, the remote terminal equipment using the mode-1 resource allocation mode releases a direct path and switches to using the mode-2 resource allocation mode. Therefore, after the remote terminal equipment using the mode-1 resource allocation mode in multi-mode operations releases a direct path, its indirect path may use the mode-2 resource allocation mode for operation, thereby avoiding the problem that the remote terminal equipment and the network device are unable to communicate after the direct path is released.

### Embodiments of a Nineteenth Aspect

The embodiments of this disclosure provide a path processing apparatus. The apparatus may be, for example, a network device, or may be one or some components or assemblies configured in the network device. The embodiments correspond to the embodiments of the thirteenth aspect, and identical contents shall not be described herein any further.

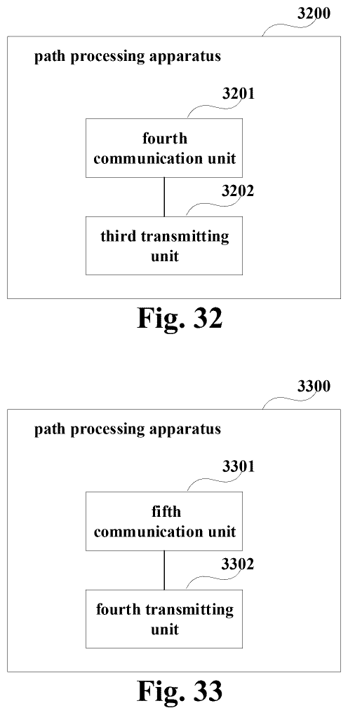

FIG. 32 is a schematic diagram of the path processing apparatus of the embodiments of this disclosure. As shown in FIG. 32, a path processing apparatus 3200 includes:
a fourth communication unit 3201 configured to communicate via a direct path and an indirect path with a remote terminal equipment using a mode-1 resource allocation mode; and
a third transmitting unit 3202 configured to transmit second indication information to the remote terminal equipment, the second indication information including information indicating that the remote terminal equipment uses the mode-2 resource allocation mode in a case where a direct path is released.

According to the above embodiments, in multi-path operations, the network device transmits the second indication information to the remote terminal equipment using the mode-1 resource allocation mode via a direct path and/or an indirect path, indicating that the remote terminal equipment uses the mode-2 resource allocation mode in case of releasing a direct path, so that the remote terminal equipment switches the mode-1 resource allocation mode to the mode-2 resource allocation mode based on the second indication information in case of releasing a direct path. Therefore, after the remote terminal equipment using the mode-1 resource allocation mode in multi-path operations releases a direct path, its indirect path may use the mode-2 resource allocation mode for operation, thereby avoiding the problem that the remote terminal equipment using the mode-1 resource allocation mode and the network device are unable to communicate after the direct path is released.

In the embodiments, the apparatus further includes a fourth receiving unit (not shown in figures) configured to receive a request message transmitted by the remote terminal equipment;
and the third transmitting unit 3202 transmits the second indication information to the remote terminal equipment according to the request message.

In the embodiments, the request message is a sidelink UE information message;
and the third transmitting unit 3202 is configured to transmit the second indication information to the remote terminal equipment according to the sidelink UE information message.

It should be noted that the components or modules related to this disclosure are only described above. However, this disclosure is not limited thereto, and the path processing apparatus 3200 may further include other components or modules, and reference may be made to related techniques for particulars of these components or modules.

Furthermore, for the sake of simplicity, connection relationships between the components or modules or signal profiles thereof are only illustrated in FIG. 32. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

According to the above embodiments, in multi-path operations, the network device transmits the second indication information to the remote terminal equipment using the mode-1 resource allocation mode via a direct path and/or an indirect path, indicating that the remote terminal equipment uses the mode-2 resource allocation mode in case of releasing a direct path, so that the remote terminal equipment switches the mode-1 resource allocation mode to the mode-2 resource allocation mode based on the second indication information in case of releasing a direct path. Therefore, after the remote terminal equipment using the mode-1 resource allocation mode in multi-path operations releases a direct path, its indirect path may use the mode-2 resource allocation mode for operation, thereby avoiding the problem that the remote terminal equipment and the network device are unable to communicate after the direct path is released.

### Embodiments of a Twentieth Aspect

The embodiments of this disclosure provide a path processing apparatus. The apparatus may be, for example, a network device, or may be one or some components or assemblies configured in the network device. The embodiments correspond to the embodiments of the fourteenth aspect, and identical contents shall not be described herein any further.

FIG. 33 is a schematic diagram of the path processing apparatus of the embodiments of this disclosure. As shown in FIG. 33, a path processing apparatus 3300 includes:
a fifth communication unit 3301 configured to communicate via a direct path and an indirect path with a remote terminal equipment using a mode-1 resource allocation mode; and
a fourth transmitting unit 3302 configured to transmit third indication information to the remote terminal equipment, the third indication information including information indicating to release a direct path and information indicating to use a mode-2 resource allocation mode in a case of releasing a direct path.

It should be noted that the components or modules related to this disclosure are only described above. However, this disclosure is not limited thereto, and the path processing apparatus 3300 may further include other components or modules, and reference may be made to related techniques for particulars of these components or modules.

Furthermore, for the sake of simplicity, connection relationships between the components or modules or signal profiles thereof are only illustrated in FIG. 33. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

According to the above embodiments, in multi-path operations, the network device transmits the third indication information to the remote terminal equipment using the mode-1 resource allocation mode via a direct path and/or an indirect path, so that the remote terminal equipment releases a direct path according to the third indication information and uses the mode-2 resource allocation mode in case of releasing a direct path. Therefore, after the remote terminal equipment using the mode-1 resource allocation mode in multi-path operations releases a direct path, its indirect path may use the mode-2 resource allocation mode for operation, thereby avoiding the problem that the remote terminal equipment and the network device are unable to communicate after the direct path is released.

### Embodiments of a Twenty-first Aspect

The embodiments of the disclosure provide a path processing apparatus. The apparatus may be, for example, a relay terminal equipment, or may be one or some components or assemblies configured in the relay terminal equipment. The embodiments correspond to the embodiments of the third aspect, and identical contents shall not be described herein any further.

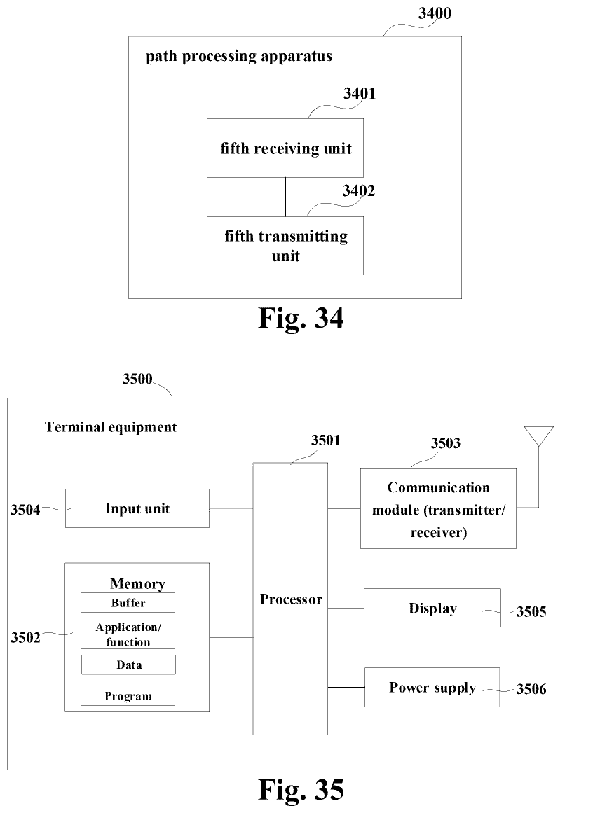

FIG. 34 is a schematic diagram of the path processing apparatus of the embodiments of this disclosure. As shown in FIG. 34, a path processing apparatus 3400 includes:
a fifth receiving unit 3401 configured to receive first indication information transmitted by a network device, the first indication information including an indication for adding or changing a direct path; and
a fifth transmitting unit 3402 configured to transmit the first indication information to a remote terminal equipment.

In the embodiments, the fifth receiving unit 3401 is further configured to receive configuration information transmitted by the network device, the configuration information including configuration of an indirect path;
and the fifth transmitting unit is further configured to transmit the configuration information to a remote UE.

In the embodiments, the fifth receiving unit 3401 is further configured to receive an RRC reestablishment request message or failure information transmitted by the remote UE in adding or changing a direct path according to the first indication information and the adding or changing a direct path fails;
and the fifth transmitting unit is further configured to transmit the RRC reestablishment request message or failure information to the network device.

### Embodiments of a Twenty-Second Aspect

The embodiments of this disclosure provide a remote terminal equipment, including the path processing apparatus as described in the embodiments of the fifteenth aspect.

### Embodiments of a Twenty-Third Aspect

The embodiments of this disclosure provide a network device, including the path processing apparatus as described in the embodiments of the sixteenth aspect.

### Embodiments of a Twenty-Fourth Aspect

The embodiments of this disclosure provide a relay terminal equipment, including the path processing apparatus as described in the embodiments of the seventeenth aspect.

### Embodiments of a Twenty-Fifth Aspect

The embodiments of this disclosure provide a communication system, including the remote terminal equipment as described in the embodiments of the twenty-second aspect, the network device as described in the embodiments of the twenty-third aspect and the relay terminal equipment as described in the embodiments of the twenty-fourth aspect.

### Embodiments of a Twenty-Sixth Aspect

The embodiments of this disclosure provide a remote terminal equipment, including the path processing apparatus as described in the embodiments of the eleventh aspect.

### Embodiments of a Twenty-Seventh Aspect

The embodiments of this disclosure provide a network device, including the path processing apparatus as described in the embodiments of the thirteenth aspect.

### Embodiments of a Twenty-Eighth Aspect

The embodiments of this disclosure provide a communication system, including the remote terminal equipment as described in the embodiments of the twenty-sixth aspect and the network device as described in the embodiments of the twenty-seventh aspect.

### Embodiments of a Twenty-Ninth Aspect

The embodiments of this disclosure provide a remote terminal equipment, including the path processing apparatus as described in the embodiments of the twelfth aspect.

### Embodiments of a Thirtieth Aspect

The embodiments of this disclosure provide a network device, including the path processing apparatus as described in the embodiments of the fourteenth aspect.

### Embodiments of a Thirty-First Aspect

The embodiments of this disclosure provide a communication system, including the remote terminal equipment as described in the embodiments of the twenty-ninth aspect and the network device as described in the embodiments of the thirtieth aspect.

### Embodiments of a Thirty-Second Aspect

The embodiments of this disclosure provide a communication system, and reference may be made to FIG. 1, with contents identical to those in the embodiments of the first to the fourteenth aspects being not going to be described herein any further.

In some embodiments, the communication system 100 may include a remote terminal equipment 101 and/or a relay terminal equipment 102 and/or a network device 103.

In the embodiments of this disclosure, the remote terminal equipment 101 is configured to carry out the path processing method in the embodiments of at least one of the first and the eighth to the twelfth aspects, the contents of which being incorporated herein, which shall not be described herein any further.

In the embodiments of this disclosure, the relay terminal equipment 102 is configured to transmit data of the remote terminal equipment 101 to the network device 103 or transmit data of the network device 103 to the remote terminal equipment 101 in the embodiments of the third aspect, the contents of which being incorporated herein, which shall not be described herein any further.

In the embodiments of this disclosure, the network device 103 is configured to carry out the path processing method in the embodiments of the second aspect and/or the thirteenth aspect and/or the fourteenth aspect, the contents of which being incorporated herein, which shall not be described herein any further.

The embodiments of this disclosure further provide a remote terminal equipment.

FIG. 35 is a schematic diagram of a structure of the terminal equipment of the embodiments of this disclosure. The terminal equipment may be a remote terminal equipment. As shown in FIG. 35, a terminal equipment 3500 may include a processor 3501 and a memory 3502, the memory 3502 storing data and a program and being coupled to the processor 3501. It should be noted that this figure is illustrative only, and other types of structures may also be used, so as to supplement or replace this structure and achieve a telecommunications function or other functions.

For example, the processor 3501 may be configured to execute a program to carry out the path processing method in the embodiments of the first aspect. For example, the processor 3501 may be configured to executed the following operations: receiving first indication information transmitted by a network device, the first indication information including an indication for adding or changing a direct path; and initiating RRC reestablishment or transmitting failure information to the network device when a direct path is added or changed according to the first indication information and the adding or changing a direct path fails.

For another example, the processor 3501 may be configured to execute a program to carry out the multi-path processing method in the embodiments of the eighth aspect. For example, the processor 3501 may be configured to executed the following operations: communicating with a network device via a direct path and an indirect path; and releasing the direct path, wherein a primary cell (PCell) of the remote terminal equipment is a primary cell on the released direct path, or a primary cell of the remote terminal equipment is a serving cell of a relay terminal equipment on the indirect path.

For a further example, the processor 3501 may be configured to execute a program to carry out the path processing method in the embodiments of the ninth aspect. For example, the processor 3501 may be configured to executed the following operations: communicating with a network device via a direct path and an indirect path; receiving a message from the network terminal for releasing a direct path; and releasing direct path by the remote terminal equipment according to the message transmitted the network terminal for releasing a direct path, wherein a primary cell (PCell) of the remote terminal equipment is a primary cell on the released direct path, or, a primary cell of the remote terminal equipment is a serving cell of the relay terminal equipment on the indirect path.

For still another example, the processor 3501 may be configured to execute a program to carry out the path processing method in the embodiments of the tenth aspect. For example, the processor 3501 may be configured to executed the following operations: communicating with a network device by using a direct path and an indirect path in a mode-1 resource allocation mode; releasing direct path; and using a mode-2 resource allocation mode.

For further still another example, the processor 3501 may be configured to execute a program to carry out the path processing method in the embodiments of the eleventh aspect. For example, the processor 3501 may be configured to executed the following operations: receiving second indication information transmitted by the network device, the second indication information including information indicating that the remote terminal equipment uses the mode-2 resource allocation mode; and using the mode-2 resource allocation mode in case of releasing a direct path.

For another example, the processor 3501 may be configured to execute a program to carry out the path processing method in the embodiments of the twelfth aspect. For example, the processor 3501 may be configured to executed the following operations: transmitting a request message to the network device; receiving third indication information fed back by the network device according to the request information, the third indication information including information indicating that the remote UE uses a mode-2 resource allocation mode; releasing a direct path; in a case of releasing a direct path, using information of the mode-2 resource allocation mode according to the third indication information.

For yet another example, the terminal equipment may be a relay terminal equipment. The processor 3501 may be configured to execute a program to carry out the path processing method in the embodiments of the third aspect. For example, the processor 3501 may be configured to executed the following operations: receiving first indication information transmitted by a network device, the first indication information including an indication for adding or changing a direct path; and transmitting the first indication information to a remote UE.

As shown in FIG. 35, the terminal equipment 3500 may further include a communication module 3503, an input unit 3504, a display 3505, and a power supply 3506, wherein functions of the above components are similar to those in the related art, which shall not be described herein any further. It should be noted that the terminal equipment 3500 does not necessarily include all the parts shown in FIG. 35, and the above components are not necessary. Furthermore, the terminal equipment 3500 may include parts not shown in FIG. 35, and the related art may be referred to.

The embodiments of this disclosure further provide a network device, which may be, for example, a base station. However, this disclosure is not limited thereto, and it may also be another network device.

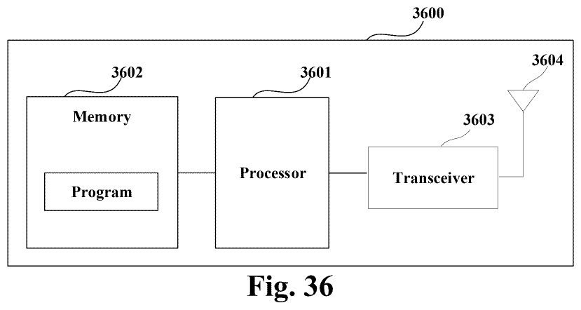

FIG. 36 is a schematic diagram of a structure of the network device of the embodiments of the seventh aspect of this disclosure. As shown in FIG. 36, a network device 3600 may include a processor 3601 (such as a central processing unit (CPU)) and a memory 3602, the memory 3602 being coupled to the processor 3601. The memory 3602 may store various data, and furthermore, it may store a program for information processing, and execute the program under control of the processor 3601.

For example, the processor 3601 may be configured to execute a program to carry out the path processing method in the embodiments of the second aspect. For example, the processor 3601 may be configured to executed the following operations: transmitting first indication information to a remote terminal equipment (remote UE), the first indication information including an indication for adding or changing a direct path; and receiving an RRC reestablishment request message or failure information transmitted by the remote UE in adding or changing a direct path according to the first indication information and the adding or changing a direct path fails.

For another example, the processor 3601 may be configured to execute a program to carry out the multi-path processing method in the embodiments of the thirteenth aspect. For example, the processor 3601 may be configured to executed the following operations: communicating with a remote terminal equipment using a mode-1 resource allocation mode via a direct path and an indirect path; and transmitting second indication information to the remote terminal equipment, the second indication information including information indicating that the remote terminal equipment uses a mode-2 resource allocation mode in case of releasing a direct path.

For another example, the processor 3601 may be configured to execute a program to carry out the multi-path processing method in the embodiments of the fourteenth aspect. For example, the processor 3601 may be configured to executed the following operations: communicating with a remote terminal equipment using a mode-1 resource allocation mode via a direct path and an indirect path; and transmitting third indication information to the remote terminal equipment, the third indication information including information indicating to release a direct path and information indicating to use a mode-2 resource allocation mode in a case of releasing a direct path.

Furthermore, as shown in FIG. 36, the network device 3600 may include a transceiver 3603, and an antenna 3604, etc. Functions of the above components are similar to those in the related art, and shall not be described herein any further. It should be noted that the network device 3600 does not necessarily include all the parts shown in FIG. 36, and furthermore, the network device 3600 may include parts not shown in FIG. 36, and the related art may be referred to.

Embodiments of this disclosure provide a computer program, which, when executed in a remote terminal equipment, causes a computer to carry out the path processing method as described in the embodiments of the first aspect and/or the eighth aspect and/or the ninth aspect and/or the tenth aspect and/or the eleventh aspect and/or the twelfth aspect in the remote terminal equipment.

Embodiments of this disclosure provide a storage medium, including a computer program, which causes a computer to carry out the path processing method as described in the embodiments of the first aspect and/or the eighth aspect and/or the ninth aspect and/or the tenth aspect and/or the eleventh aspect and/or the twelfth aspect in a remote terminal equipment.

Embodiments of this disclosure provide a computer program, which, when executed in a network device, causes a computer to carry out the path processing method as described in the embodiments of the second aspect and/or the thirteenth aspect and/or the fourteenth aspect in the network device.

Embodiments of this disclosure provide a computer storage medium, including a computer program, which causes a computer to carry out the multi-path processing method as described in the embodiment(s) of the second aspect and/or the thirteenth aspect and/or the fourteenth aspect in a network device.

Embodiments of this disclosure provide a computer program, which, when executed in a relay terminal equipment, causes a computer to carry out the path processing method as described in the embodiments of the third aspect in the relay terminal equipment.

Embodiments of this disclosure provide a storage medium, including a computer program, which causes a computer to carry out the path processing method as described in the embodiments of the third aspect in a relay terminal equipment.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.

### Methods at a remote terminal equipment side

1. A path processing method, applicable to a remote terminal equipment, the method including: receiving first indication information transmitted by a network device, the first indication information including an indication for adding or changing a direct path; and initiating RRC reestablishment or transmitting failure information to the network device when a direct path is added or changed according to the first indication information and the adding or changing a direct path fails.
2. The method according to supplement 1, wherein the method further includes: initiating RRC reestablishment or transmitting the failure information to the network device by using a configuration before the first indication information is received or a default configuration.
3. The method according to supplement 2, wherein in a case where the first indication information includes an indication for adding a direct path, the configuration before the first indication information is received includes: a configuration in communicating with the network device by using an indirect path;
and in a case where the first indication information includes an indication for changing a direct path, the configuration before the first indication information is received includes: a configuration in communicating with the network device by using a direct path and/or an indirect path.
4. The method according to supplement 1, wherein the method further includes: receiving configuration information transmitted by the network device, the configuration information including configuration of an indirect path;
and the method further includes: initiating RRC reestablishment or transmitting the failure information to the network device by using the configuration of the indirect path.
5. The method according to supplement 1, wherein the method further includes:
initiating cell selection or relay terminal equipment selection in a case where an RRC reestablishment procedure is initiated.
6. The method according to supplement 1, wherein the transmitting failure information to the network device in the case where the first indication information includes an indication for adding a direct path includes: transmitting the failure information to the network device via an indirect path.
7. The method according to supplement 6, wherein the method further includes: communicating with the network device by using a configuration of the indirect path before the first indication information is received or a configuration of the indirect path in the default configuration.
8. The method according to supplement 6, wherein the first indication information further includes the configuration of the indirect path;
and the method further includes: transmitting the failure information to the network device by using the configuration of the indirect path included in the first indication information.
9. The method according to supplement 1, wherein that the transmitting failure information to the network device in the case where the first indication information includes an indication for changing a direct path includes: transmitting the failure information to the network device via a direct path and/or an indirect path.
10. The method according to supplement 9, wherein the method further includes: transmitting the failure information to the network device by using a configuration of a direct path and/or an indirect path before the first indication information is received, or, transmitting the failure information to the network device by using a configuration of a direct path and/or an indirect path in a default configuration.
11. The method according to supplement 9, wherein the method further includes:
receiving configuration information, the configuration information including a configuration of an indirect path; and
transmitting the failure information to the network device by using the configuration of the indirect path.
12. The method according to supplement 1, wherein the failure information includes a cause for failure.
13. The method according to supplement 12, wherein the cause for failure includes at least one of the following: failure in adding a direct path, failure in random access, failure in changing a direct path, or expiration of T304.
14. The method according to supplement 1, wherein the failure information is an RRC message or an indication message of a lower layer.
15. A path processing method, applicable to a remote terminal equipment, the method including:
communicating with a network device via a direct path and an indirect path, and releasing the direct path,
wherein a primary cell (PCell) of the remote terminal equipment is a primary cell on the released direct path, or a primary cell of the remote terminal equipment is a serving cell of a relay terminal equipment on the indirect path.
16. The method according to supplement 15, wherein the serving cell of the relay terminal equipment includes a primary cell (PCell) or a secondary cell (SCell) or a primary SCG cell (PSCell) of the relay terminal equipment.
17. The method according to supplement 15, wherein the method further includes:
receiving a message transmitted by the network device for releasing a direct path, the message including a configuration of an indirect path;
and the releasing a direct path includes:
releasing the direct path according to the message for releasing a direct path.
18. A path processing method, applicable to a remote terminal equipment, wherein the remote terminal equipment communicates with a network device by using a direct path and an indirect path and uses a mode-1 resource allocation mode, and the method includes:
releasing a direct path; and
using a mode-2 resource allocation mode.
19. The method according to supplement 18, wherein the remote terminal equipment autonomously switches the mode-1 resource allocation mode to the mode-2 resource allocation mode.
20. The method according to supplement 19, wherein the method further includes:
communicating with a relay terminal equipment by using preconfigured resource pool configuration information or resource pool configuration information in system information of a serving cell of a relay terminal equipment (relay UE) on the indirect path.
21. The method according to supplement 18, wherein the method further includes:
receiving, by the remote terminal equipment, second indication information transmitted by the network device, the second indication information including information indicating that the remote terminal equipment uses the mode-2 resource allocation mode; and
using the mode-2 resource allocation mode according to the second indication information.
22. The method according to supplement 21, wherein the second indication information further includes resource pool configuration information.
23. The method according to supplement 22, wherein the method further includes: communicating with the relay terminal equipment by the remote terminal equipment by using the resource pool configuration information included in the second indication information.
24. The method according to supplement 21, wherein the method further includes:
receiving a message for releasing a direct path transmitted by the network device,
the releasing a direct path including:
releasing a direct path according to the message for releasing a direct path.
25. The method according to supplement 24, wherein the second indication information is included in the message for releasing a direct path.
26. The method according to supplement 21, wherein the method further includes:
transmitting a sidelink UE information message to the network device before receiving the second indication information; and
receiving the second indication information fed back by the network device according to the sidelink UE information message.

### Methods at a Network Device Side

27. A path processing method, applicable to a network device, the method including:
transmitting first indication information to a remote terminal equipment, the first indication information including an indication for adding or changing a direct path; and
receiving an RRC reestablishment request message or failure information transmitted by the remote terminal equipment in adding or changing a direct path according to the first indication information and the adding or changing a direct path fails.
28. The method according to supplement 27, wherein in a case where the first indication information includes an indication for adding a direct path, the RRC reestablishment request message or failure information transmitted by the remote terminal equipment in adding a direct path according to the first indication information and the adding a direct path fails is received via an indirect path,
and in a case where the first indication information includes an indication for changing a direct path, the RRC reestablishment request message or failure information transmitted by the remote terminal equipment in changing a direct path according to the first indication information and the changing a direct path fails is received via a direct path and/or an indirect path.
29. The method according to supplement 27, wherein the method further includes: receiving the RRC reestablishment request message or failure information by using a configuration before the remote terminal equipment receives the first indication information or a default configuration.
30. The method according to supplement 27, wherein the method further includes: receiving configuration information, the configuration information including a configuration of an indirect path;
receiving the RRC reestablishment request message or failure information by using the configuration of the indirect path.
31. A path processing method, applicable to a network device, the method including:
communicating with a remote terminal equipment using a mode-1 resource allocation mode by a network device via a direct path and an indirect path;
transmitting second indication information to the remote terminal equipment when the remote terminal equipment releases the direct path.
32. The method according to supplement 31, wherein the method further includes:
receiving a request message transmitted by the remote terminal equipment;
and the transmitting second indication information to the remote terminal equipment includes:
transmitting the second indication information to the remote terminal equipment according to the request message.
33. The method according to supplement 32, wherein the request message is a sidelink UE information message;
and the transmitting the second indication information to the remote terminal equipment according to the request message includes:
transmitting the second indication information to the remote terminal equipment according to the sidelink UE information message.
34. A path processing method, applicable to a network device, the method including:
communicating via a direct path and an indirect path with a remote terminal equipment using a mode-1 resource allocation mode;
transmitting third indication information to the remote terminal equipment, the third indication information including information indicating to release a direct path and information indicating to use a mode-2 resource allocation mode in a case of releasing a direct path.

### Apparatuses at a Remote Terminal Equipment Side

35. A path processing apparatus, applicable to a remote terminal equipment, the apparatus including:
a first receiving unit configured to receive first indication information transmitted by a network device, the first indication information including an indication for adding or changing a direct path; and
a first processing unit configured to initiate RRC reestablishment or transmit failure information to the network device when a direct path is added or changed according to the first indication information and the adding or changing a direct path fails.
36. The apparatus according to supplement 35, wherein that the first processing unit transmits failure information to the network device in the case where the first indication information includes an indication for changing a direct path includes: transmitting the failure information to the network device via a direct path and/or an indirect path.
37. The apparatus according to supplement 36, wherein the first receiving is further configured to receive configuration information, the configuration information including configuration of an indirect path;
and the first processing unit communicates with the network device by using the configuration of the indirect path.
38. A path processing apparatus, applicable to a remote terminal equipment, wherein the remote terminal equipment communicates with a network device by using a direct path and an indirect path and uses a mode-1 resource allocation mode, and the apparatus includes:
a second releasing unit configured to release a direct path; and
a second processing unit configured to use a mode-2 resource allocation mode.
39. The apparatus according to supplement 38, wherein the second processing unit is configured to autonomously switches the mode-1 resource allocation mode to the mode-2 resource allocation mode.
40. The apparatus according to supplement 39, wherein the apparatus further includes a second communication unit configured to communicate with a relay terminal equipment by using preconfigured resource pool configuration information or resource pool configuration information in system information of a serving cell of a relay terminal equipment (relay UE) on the indirect path.
41. The apparatus according to supplement 38, wherein the apparatus further includes:
a third receiving unit configured to receive second indication information transmitted by the network device, the second indication information including information indicating that the remote terminal equipment uses the mode-2 resource allocation mode;
and the second processing unit is configured to use the mode-2 resource allocation mode according to the second indication information.
42. The apparatus according to supplement 41, wherein the second indication information further includes resource pool configuration information.
43. The apparatus according to supplement 42, wherein the apparatus further includes a third communication unit configured to communicate with the relay terminal equipment by using the resource pool configuration information included in the second indication information.
44. The apparatus according to supplement 41, wherein the apparatus further includes:
a fourth receiving unit configured to receive a message for releasing a direct path transmitted by the network device,
and the second releasing unit is configured to release a direct path according to the message for releasing a direct path.
45. The apparatus according to supplement 44, wherein the second indication information is included in the message for releasing a direct path.
46. The apparatus according to supplement 41, wherein the apparatus further includes a second transmitting unit configured to:
transmit a sidelink UE information message to the network device before receiving the second indication information;
and the third receiving unit receives the second indication information fed back by the network device according to the sidelink UE information message.

### Apparatuses at a Network Device Side

47. A path processing apparatus, applicable to a network device, the apparatus including: a fourth communication unit configured to communicate via a direct path and an indirect path with a remote terminal equipment using a mode-1 resource allocation mode; and
a third transmitting unit configured to transmit second indication information to the remote terminal equipment, the second indication information including information indicating that the remote terminal equipment uses the mode-2 resource allocation mode in a case where a direct path is released.
48. The apparatus according to supplement 47, wherein,
the apparatus further includes a fourth receiving unit configured to receive a request message transmitted by the remote terminal equipment;
and the third transmitting unit transmits the second indication information to the remote terminal equipment according to the request message.
49. The apparatus according to supplement 48, wherein the request message is a sidelink UE information message;
and the fourth transmitting unit is configured to transmit the second indication information to the remote terminal equipment according to the sidelink UE information message.
50. A path processing apparatus, applicable to a network device, the apparatus including:
a fifth communication unit configured to communicate via a direct path and an indirect path with a remote terminal equipment using a mode-1 resource allocation mode; and
a fourth transmitting unit configured to transmit third indication information to the remote terminal equipment, the third indication information including information indicating to release a direct path and information indicating to use a mode-2 resource allocation mode in a case of releasing a direct path.

### A Method at a Relay Terminal Equipment Side

51. A path processing method, applicable to a relay terminal equipment, the method including:
receiving first indication information transmitted by a network device, the first indication information including an indication for adding or changing a direct path; and
transmitting the first indication information to a remote terminal equipment.
52. The method according to supplement 51, wherein the method further includes:
receiving configuration information transmitted by the network device, the configuration information including configuration of an indirect path; and
transmitting the configuration information to a remote UE.
53. The method according to supplement 51 or 52, wherein the method further includes:
receiving an RRC reestablishment request message or failure information transmitted by the remote UE in adding or changing a direct path according to the first indication information and the adding or changing a direct path fails; and
transmitting the RRC reestablishment request message or failure information to the network device.

### An Apparatus at a Relay Terminal Equipment Side

54. A path processing apparatus, applicable to a relay terminal equipment, the apparatus including:
a fifth receiving unit configured to receive first indication information transmitted by a network device, the first indication information including an indication for adding or changing a direct path; and
a fifth transmitting unit configured to transmit the first indication information to a remote terminal equipment.
55. The apparatus according to supplement 54, wherein,
the fifth receiving unit is further configured to receive configuration information transmitted by the network device, the configuration information including configuration of an indirect path;
and the fifth transmitting unit is further configured to transmit the configuration information to a remote UE.
56. The apparatus according to supplement 54 or 55, wherein,
the fifth receiving unit is further configured to receive an RRC reestablishment request message or failure information transmitted by the remote UE in adding or changing a direct path according to the first indication information and the adding or changing a direct path fails;
and the fifth transmitting unit is further configured to transmit the RRC reestablishment request message or failure information to the network device.

1. A path processing apparatus, applicable to a remote terminal equipment configured with an indirect path, the apparatus comprising:
a first receiver configured to receive first indication information transmitted by a network device, the first indication information comprising an indication for adding or changing a direct path in addition to the indirect path; and
first processor circuitry configured to initiate RRC reestablishment when a direct path is added or changed according to the first indication information and the adding or changing a direct path fails.

2. The apparatus according to claim 1, wherein the first processor circuitry initiates RRC reestablishment by using a configuration before the first indication information is received or a default configuration.

3. The apparatus according to claim 2, wherein in a case where the first indication information comprises an indication for adding a direct path, the configuration before the first indication information is received comprises: a configuration in communicating with the network device by using an indirect path; and
in a case where the first indication information comprises an indication for changing a direct path, the configuration before the first indication information is received comprises: a configuration in communicating with the network device by using a direct path and/or an indirect path.

4. The apparatus according to claim 1, wherein the first receiver is further configured to receive configuration information, the configuration information comprising configuration of an indirect path; and
the first processor circuitry initiates RRC reestablishment by using the configuration of the indirect path.

5. The apparatus according to claim 1, wherein,
the first processor circuitry is configured to initiate cell selection or relay terminal equipment selection in a case where an RRC reestablishment procedure is initiated.

6. A path processing apparatus, applicable to a network device, the apparatus comprising:
a first transmitter configured to transmit first indication information to a remote terminal equipment, the first indication information comprising an indication for adding or changing a direct path; and
a second receiver configured to receive an RRC reestablishment request message or failure information transmitted by the remote terminal equipment in adding or changing a direct path according to the first indication information and the adding or changing a direct path fails.

7. The apparatus according to claim 6, wherein the second receiver is configured to,
in a case where the first indication information comprises an indication for adding a direct path, receive via an indirect path the RRC reestablishment request message or failure information transmitted by the remote terminal equipment in adding a direct path according to the first indication information and the adding a direct path fails, and
in a case where the first indication information comprises an indication for changing a direct path, receive via a direct path and/or an indirect path the RRC reestablishment request message or failure information transmitted by the remote terminal equipment in changing a direct path according to the first indication information and the changing a direct path fails.

8. The apparatus according to claim 6, wherein the second receiver is further configured to receive the RRC reestablishment request message or failure information by using a configuration before the remote terminal equipment receives the first indication information or a default configuration.

9. The apparatus according to claim 6, wherein the first transmitter is further configured to transmit configuration information to the remote terminal equipment, the configuration information comprising a configuration of an indirect path; and
the second receiver is further configured to receive the RRC reestablishment request message or failure information by using the configuration of the indirect path.

10. A path processing apparatus, applicable to a remote terminal equipment, the apparatus comprising:
first communication processor circuitry configured to:
communicate with a network device via a direct path and an indirect path; and
receive a Radio Resource Control (RRC) reconfiguration message for path switching transmitted by the network device for releasing the direct path, the message comprising a configuration of the indirect path;
first releasing processor circuitry configured to release the direct path according to the message for releasing the direct path.

11. The apparatus according to claim 10, wherein a serving cell of a relay terminal equipment on the indirect path comprises a primary cell (PCell) or a secondary cell (SCell) or a primary SCG cell (PSCell) of the relay terminal equipment.
